(19) United States
(12) Patent Application Publication
(10) Pub. No.: US 2013/0197932 A1
(43) Pub. Date: Aug. 1, 2013

(54) System and Method for Healthcare Decision Support

(71) Applicants: Stephen J. Herman, Toronto (CA); Priyanga Manoharan, Scarborough (CA); David Judd, Markham (CA)

(72) Inventors: Stephen J. Herman, Toronto (CA); Priyanga Manoharan, Scarborough (CA); David Judd, Markham (CA)

(73) Assignee: MEDCURRENT CORPORATION, Toronto, ON (CA)

(21) Appl. No.: 13/825,662

(22) PCT Filed: Sep. 24, 2010
(86) PCT No.: PCT/CA10/01484

§ 371 Date: Mar. 22, 2013

(51) Int. Cl. G06F 19/00

(52) U.S. Cl. CPC G06F 19/345
USPC 705/2

(57) ABSTRACT

Systems and methods are provided for providing decision making support in healthcare. A user is able to provide healthcare data, including qualifier, indications, body part modifiers, body parts, modality modifiers, modalities, procedures and protocols. A graphical user interface (GUI) is provided to allow procedure rules to be created by selecting components of the healthcare data. The procedure rules identify and recommend appropriate procedures based on user input. The GUI also allows for global rules, body part rules, modality rules and modality modifier rules to be created; these rules are contra-indicators to procedures. Upon establishing the rules, a physician can enter data about a patient into the system, and the system will use the rules to return one or more appropriate procedures.

### TECHNICAL FIELD

The following relates generally to providing healthcare data.

### DESCRIPTION OF THE RELATED ART

In the field of healthcare, physicians and other medical workers recommend or request tests and procedures be carried out on patients. This occurs in healthcare fields including, for example, radiology, medicine, dentistry, physiotherapy, optometry, oncology, paediatrics, veterinary medicine, etc. The tests or procedures are typically determined based on the patient's symptoms and their physical state. For example, if a patient experienced a concussion and has headaches, they are ordered a magnetic resonance imaging (MRI) scan of the head for further study. In another example, if a patient is diagnosed with a cancerous lump, they are ordered surgical treatment.

Determining an appropriate test or procedure for a patient can be difficult, as there are many factors to consider. Furthermore, where there is uncertainty whether which tests or procedures are appropriate for a patient, it is typical for a healthcare worker to order multiple tests and treatments in an attempt to reduce uncertainty. For example, an MRI scan and a computed tomography (CT) scan are ordered for a patient having a headache to gather more information to determine the cause of the headache. However, many times, some of the ordered tests and treatments are not necessary and are extraneous to the patient's needs. For example, the MRI scan may be sufficient for the patient, and the CT scan would not provide any additional beneficial information. It can therefore be understood that ordered tests and procedures are sometimes unnecessary.

Ordering unnecessary tests and procedures can create additional harm to a patient, consumes valuable healthcare resources (e.g. professional time, medical equipment, healthcare institution space, etc.), and costs money to the payers (e.g. patients, insurance companies, government, etc.).

There is therefore a desire to reduce the number of unnecessary ordered tests and procedures.

### BRIEF DESCRIPTION OF THE DRAWINGS

Embodiments of the invention or inventions will now be described by way of example only with reference to the appended drawings wherein:

FIG. 1 is a block diagram of an example computing configuration between a healthcare database and user devices.

FIG. 2 is a block diagram of example software components for a healthcare decision support system.

FIG. 3 is flow diagram illustrating example computer executable instructions for managing the healthcare system.

FIG. 4 is a flow diagram illustrating example computer executable instructions for establishing rules the healthcare decision support system.

FIG. 5 is a flow diagram illustrating example computer executable instructions for providing healthcare decision support.

FIG. 6 is a flow diagram illustrating example computer executable instructions for using a physician portal.

FIG. 7 is a flow diagram illustrating example computer executable instructions for logging into and registering a user on the physician portal.

FIG. 8 is a flow diagram illustrating example computer executable instructions for managing patients on the physician portal.

FIG. 9 is a flow diagram illustrating example computer executable instructions for viewing patients' order history on the physician portal.

FIG. 10 is a flow diagram illustrating example computer executable instructions for creating and submitting an order on the physician portal.

FIG. 11 is a flow diagram illustrating example computer executable instructions for managing an account on the physician portal.

FIG. 12 is a flow diagram illustrating example computer executable instructions for using a management studio.

FIG. 13 is a flow diagram illustrating example computer executable instructions for logging into and registering a user on the management studio.

FIG. 14 is a flow diagram illustrating example computer executable instructions for managing sites on the management studio.

FIG. 15 is a flow diagram illustrating example computer executable instructions for managing users on the management studio.

FIG. 16 is a flow diagram illustrating example computer executable instructions for managing medical terminology on the management studio.

FIG. 17 is a flow diagram illustrating example computer executable instructions for browsing orders on the management studio.

FIG. 18 is a flow diagram illustrating example computer executable instructions for managing accounts on the management studio.

FIG. 19 is a flow diagram illustrating example computer executable instructions for managing users on the management studio.

FIG. 20 is an example screenshot of a graphical user interface (GUI) in the management studio.

FIG. 21 is a flow diagram illustrating example computer executable instructions for adding a qualifier.

FIG. 22 is a flow diagram illustrating example computer executable instructions for editing a qualifier.

FIG. 23 is an example screenshot of a GUI for managing qualifiers in the management studio.

FIG. 24 is a flow diagram illustrating example computer executable instructions for adding an indication.

FIG. 25 is a flow diagram illustrating example computer executable instructions for adding an indication category.

FIG. 26 is an example screenshot of a GUI for managing indications in the management studio.

FIG. 27 is an example screenshot of a GUI for adding a new indication in the management studio.

FIG. 28 is an example screenshot of a GUI for managing indication categories in the management studio.

FIG. 29 is a flow diagram illustrating example computer executable instructions for adding a body part modifier.

FIG. 30 is an example screenshot of a GUI for managing body part modifiers in the management studio.

FIG. 31 is a flow diagram illustrating example computer executable instructions for adding a body part.

FIG. 32 is an example screenshot of a GUI for managing body parts in the management studio.

FIG. 33 is an example screenshot of a GUI for adding a new body part in the management studio.

FIG. 34 is a flow diagram illustrating example computer executable instructions for adding a modality modifier.

FIG. 35 is an example screenshot of a GUI for managing modality modifiers in the management studio.

FIG. 36 is a flow diagram illustrating example computer executable instructions for adding a modality.

FIG. 37 is an example screenshot of a GUI for managing modalities in the management studio.

FIG. 38 is an example screenshot of a GUI for adding a new modality in the management studio.

FIG. 39 is a flow diagram illustrating example computer executable instructions for adding a protocol.

FIG. 40 is an example screenshot of a GUI for managing protocols in the management studio.

FIG. 41 is a flow diagram illustrating example computer executable instructions for adding a procedure.

FIG. 42 is an example screenshot of a GUI for managing procedures in the management studio.

FIG. 43 is an example screenshot of a GUI for adding a new procedure in the management studio.

FIG. 44 is an example screenshot of a GUI for managing rules in the management studio.

FIG. 45 is a block diagram illustrating a listing of rules.

FIG. 46 is a block diagram illustrating data components of a rule operand.

FIG. 47 is a block diagram illustrating data components for evaluating a rule.

FIG. 48 is a flow diagram illustrating example computer executable instructions for adding a procedure rule.

FIG. 49 is an example screenshot of a GUI for adding rule information for a new procedure rule in the management studio.

FIG. 50 is an example screenshot of a GUI for adding a new procedure rule in the management studio.

FIG. 51 is a flow diagram illustrating example computer executable instructions for adding a modality rule.

FIG. 52 is an example screenshot of a GUI for adding a new modality rule in the management studio.

FIG. 53 is a flow diagram illustrating example computer executable instructions for adding a modality modifier value rule.

FIG. 54 is an example screenshot of a GUI for adding a new modality modifier value rule in the management studio.

FIG. 55 is a flow diagram illustrating example computer executable instructions for adding a body part rule.

FIG. 56 is an example screenshot of a GUI for adding a new body part rule in the management studio.

FIG. 57 is a flow diagram illustrating example computer executable instructions for adding a global rule.

FIG. 58 is an example screenshot of a GUI for adding a global rule in the management studio.

FIG. 59 is a flow diagram illustrating example computer executable instructions for processes in a rule engine.

FIG. 60 is an example screenshot of a GUI for testing rules by adding clinical scenario data in the management studio.

FIG. 61 is an example screenshot of a GUI for testing rules by adding clarifications data in the management studio.

FIG. 62 is an example screenshot of a GUI for testing rules by displaying the results of the recommended procedures in the management studio.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

The proposed systems and methods allow rules to be generated for determining the appropriateness of tests and procedures for a patient. The proposed systems and methods also generate appropriate tests or procedures for a patient, based on the patient's data in view of the rules.

For example, a healthcare decision support system, herein referred to as the healthcare system, includes healthcare data. The field of healthcare includes, for example, radiology, medicine, dentistry, physiotherapy, optometry, oncology, paediatrics, veterinary medicine, etc. In other words, the field of healthcare relates to the treatment and prevention of illness. Healthcare workers (e.g. doctors and other professionals) generate rules based on the healthcare data to determine which tests or procedures would be most appropriate given certain conditions. The rules are stored in the healthcare system. Other healthcare workers can access the healthcare system and provide patient data. The healthcare system compares the patient data with the rules and determines the best matching rule and thereby indicates the most appropriate tests or procedures, or both for the patient. In this way, unnecessary or inappropriate tests and procedures are not ordered for the patient.

It is also recognized that there are known healthcare decision making tools and these do not typically allow users to alter the logic or the rules used to generate recommendations. This can make it difficult for users to update and revise the decision making criteria according to individual or institutional preferences, or as new information and new procedures are accepted. Therefore, the proposed systems and method allow for users to customize and generate rules for the healthcare system in a convenient manner.

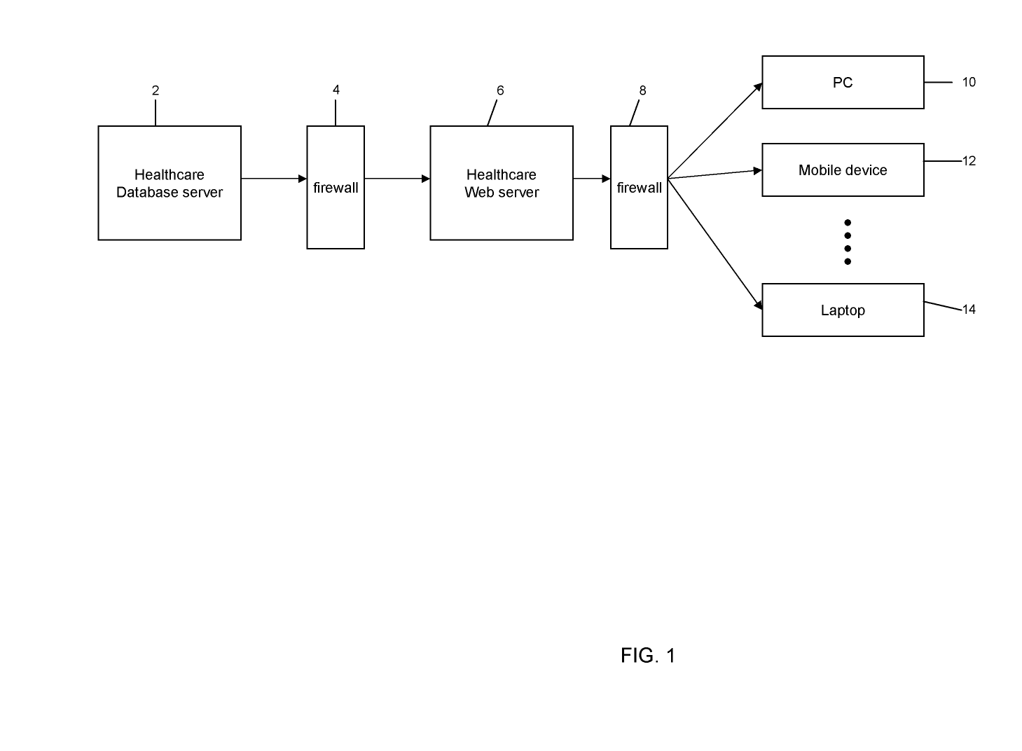

Turning to FIG. 1, an example computing configuration is provided for the healthcare system. One or more servers store and run the healthcare database 2. A web server 6 allows users to access the healthcare database 2 through the internet. For example, users can access the online healthcare system (e.g. stored on the database 2) through a personal computer 10, a mobile device 12 (e.g. smart phone, personal digital assistant, etc.) and a laptop 14. Security systems, such as firewalls 4, 6, can be placed throughout the computing components, including between the healthcare database server 2 and the web server 6, and between the web server 6 and the users' computing devices 10, 12, 14.

Other computing configurations that allow a software program to be run and accessed by one or more users are also applicable to the principles described herein. Non-limiting examples include an SAS model, on premise computing, cloud computing, and stand-alone devices. For example, the healthcare system or software, including the database and rule engine, can reside entirely on a single user device.

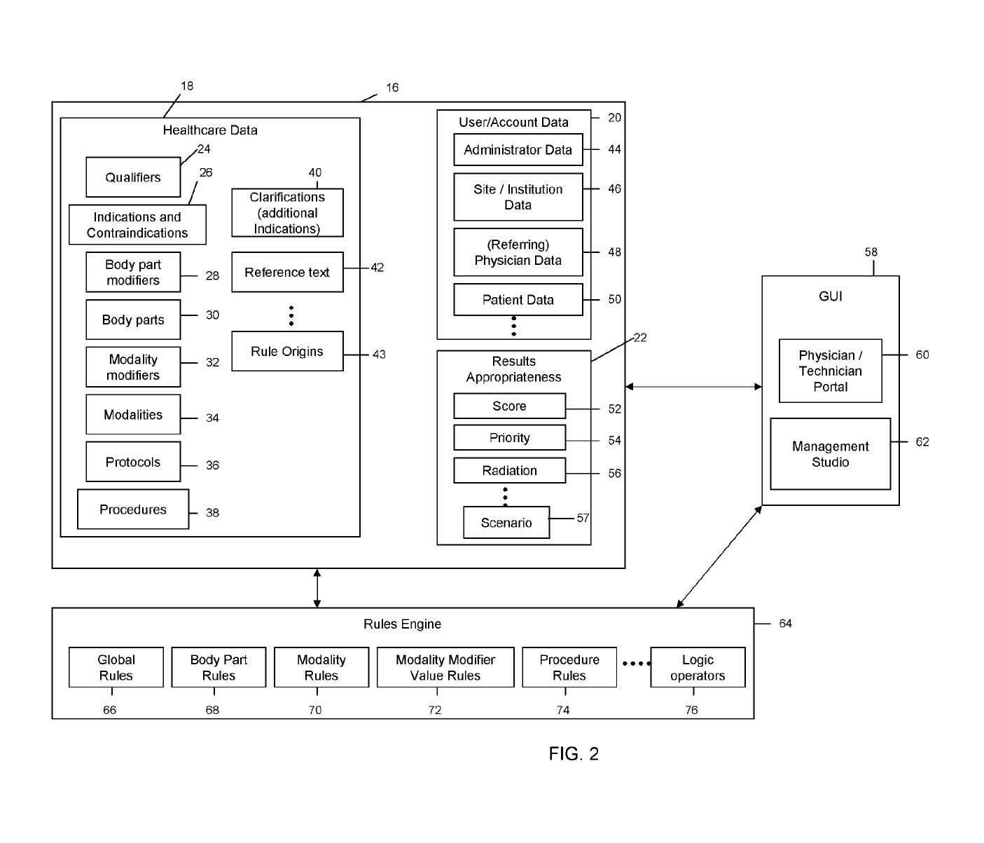

Turning to FIG. 2, example software and data components of a healthcare system are provided. The healthcare system includes a database 16, a graphical user interface (GUI) 58, and a rules engine 64 which interact with each other. The GUI 58 includes a physician/technical portal 60 and management studio 62. Physicians and other healthcare providers (e.g. radiologists, equipment operators, etc.) use the portal 60 to create orders for tests or procedures for patients. Administrative users will use the management studio 62 to generate rules, manage healthcare data, and manage account information. It can be appreciated that only administrative users have access to the management studio 62.

The database 16 stores healthcare 18, user or account data 20, and results appropriateness ratings 22. User or account data 20 includes administrator data 44, site or institution data 46, physician data 48, and patient data 50. Such data 20 comprises names, identifications, passwords, contact information, background information, notices, etc. As will be discussed below, an administrator can add a site or institution to the healthcare system. Non-limiting examples of a site or institution include a hospital, a medical clinic, and an optometry office. Then, physicians can be associated with the site or institution. Associated with each physician may be one or more patients. Different sets of healthcare data 18, results appropriateness 22 and rule engines 64 may be associated with a site or institution, a physician or a patient. In other words, the healthcare data 18, results appropriateness 22 and rule engine 64 can be customized to suit the preferences or needs of different users (e.g. a hospital, a healthcare jurisdiction, a set of patients belonging to a certain group, e.g. of a health insurance plan).

Continuing with FIG. 2, the healthcare data 18 relates to data used by the rules engine 64 to make decisions. The healthcare data 18 can be updated and customized according to the field of healthcare. The example healthcare data components described herein relate to general medicine, although can by adapted for specific healthcare fields while keeping to the principles described herein. Healthcare data components include qualifiers 24, indications and contraindications 26, body part modifiers 28, body parts 32, modalities 34, protocols 36, procedures 38, clarifications (e.g. additional indications) 40 and reference text 42. Qualifiers 24 are used to more specifically define certain characteristics or refine indications that can be defined in the healthcare system. For example, clinical course qualifiers include acute, subacute and chronic. Other qualifiers include Boolean values and integers. Indications 26 refer to symptoms, signs or conditions used to describe a scenario. Example indications include chest pain, cancer and age. Chest pain indicator can be qualified by Boolean value; the cancer indicator can be qualified by a discovery qualifier (e.g. either known or suspected); and the age indicator can be qualified with an integer. Contraindications, a type of indication, is a condition or factor that speaks against a certain measure. For example, if the patient's age is less than 1 year old (e.g. a baby), then the age is considered a contraindication for providing acetylsalicylic acid (ASA) as a treatment due to risk of developing Reye's syndrome. Body part modifiers 28 refer to additional detail or clarification of the body parts 30. For example, body part modifiers include left and right side. Body parts 30 refer to a part of the anatomy that a study, test, or procedure will be performed. Examples include abdomen, colon, neck, pelvis, paranasal sinus, etc. Body parts 30 include or are organized by parent parts. For example, a finger body part is under the parent part of the hand. Modality modifiers 32 refer to descriptors for the modality providing further details and clarification. For example, modality modifiers can include with contrast and without contrast (e.g. for MRI and CT scans). Another example of a modifier is the priority of the modifier, such as elective, emergency, routine, rescheduled, and denied. Modalities 34 refer to a categorization of studies that can be performed. Examples of modalities include MRI, CT, nuclear medicine, ultrasound, X-Ray and Positron Emission Tomography (PET). Protocols 36 refer to how a procedure should be performed. For example, a protocol can be “routine CT abdo pelvis”. Procedures 38 refer to a study to be performed on a particular body part or system with protocols defining how procedures should be executed. An example is “CT abdomen and pelvis with IV contrast”. Each procedure can be associated one or more of the following: a modality, a modality modifier, a body part, a body part modifier, and a protocol. For example, the procedure is “CT abdomen and pelvis with IV contrast”; the associated modality is “CT”; the associated modality modifier is “with contrast” and “standard”; the body part is “abdomen and pelvis”; and the protocol is “routine CT abdo pelvis”.

Clarifications 40 are additional or secondary indications and contraindications that affect which procedure or modality is appropriate for a patient. Clarifications 40 can be associated with or depend on particular (primary) indications 26. Examples of clarifications 40 include whether a patient is pregnant, has a pacemaker, is immunocomprimised (including AIDS), and has meningitis.

Healthcare data 18 may include information related to rules, such as reference text 42 and rule origins 43. Rule origins 43 refers to the origin of a rule. Examples of rule origins include the American College of Radiology (ACR), the Royal College of Radiologists (RCA), and the Canadian Association of Radiologists (CAR). Rules can also be designated as custom to account for preferences between different physicians and different institutions. Reference text 42 refers to any reference further describing the rule (e.g. rationale, related studies, etc.).

Continuing with FIG. 2, the results appropriateness ratings 22 include different appropriateness rating measures, such as by score 52, by priority 54, and by radiation dosage 56. The score 52 relates to an appropriateness rating for a procedure. The appropriateness rating or criteria can be a number scale, letters, etc. Typically the score 52 is a commonly accepted rating. For example, the ACR has an appropriateness rating scale for radiology procedures: ratings “1”, “2” and “3” are usually not appropriate; “4”,“5” and “6” may be appropriate; and “7”, “8” and “9” are usually appropriate. Other appropriateness scoring systems can be used. The priority 54 refers to the level of urgency of a recommended test or procedure. The priority ratings can be numbers, letters, etc. Radiation rating 56 provides the level of radiation that a patient may be exposed while undergoing the test or procedure. There may also be a scenario rating 57, whereby it is determined how close the scenario provided by a user matches a scenario defined in the system. Closely matched scenarios are considered more desirable when selecting a procedure to order. Based on these appropriateness ratings, a physician can select the appropriate procedure or procedures for a patient.

Scenarios or clinical scenarios include a group of indicators that describe a clinical situation. An example of a scenario is a patient having an age greater than 17 years old, having alopecia, having a headache, and the headache is severe. A scenario can be formed using the healthcare data 18.

By associating rule information with a particular scenario, a rule is formed. The rule can then be associated with a particular entity, such as a procedure, a body part, a modality, and a modality modifier, to form one of a procedure rule, a body part rule, a modality rule, and a modality modifier rule, respectively. Rules that are not associated with a particular entity are global rules. The process of authoring rules is described further below.

It can be appreciated that the healthcare data 18 is entered by the administrator through the management studio 62. The administrator also enters in rules into the rule engine 64, which are based on the entered healthcare data 18 and results appropriateness 22. Then a physician, through the portal 60, selects the parameters available in the healthcare data 18. Based on the selected parameters, a result and the corresponding appropriateness are returned to the physician.

Continuing with FIG. 2, the rules engine 64, based on the parameters inputted by a user, executes rules and returns a number of appropriate procedures and their associated appropriateness. The rules include global rules 66, body part rules 68, modality rules 70, modality modifier rules 72, and procedure rules 74. Logic operators 76 are used to form the rules. In one embodiment, all rule types except for procedure rules 74 act as contra-indicator rules. Procedure rules 74 are processed to determine an appropriateness for a test or procedure.

Global rules 66 are meant to be processed regardless of the procedure selected and apply to the entire healthcare system. A global rule includes a rule expression and rule origin for the rule. Optionally, it can include reference text and a relative rule flag. Body part rules 68 provide contra-indicators for any body part defined in the system. A body part rule includes a rule expression, reference text, a relative rule flag, rule origin, and a body part entity that the rule applies towards. Modality rules 70 provide contra-indicators for any modality defined in the system. A modality rule includes a rule expression, reference text, a relative rule flag, a rule origin, a modality entity that the rule applies towards. Modality modifier rules 72 provide contra-indicators for any modality modifier value defined in the system. A modality modifier rule includes a rule expression, reference text, a relative rule flag, a rule origin, a modality modifier value entity associated with the rule, a modality modifier entity that the modality modifier value entity belongs to, and a modality the modality modifier is applied towards. Procedure rules 74 provide an appropriateness of a procedure based on the rule expression defining the clinical scenario. A procedure rule includes a rule expression, a reference text, a rule origin, a procedure entity, a score for the rule, a priority for the procedure, a radiation dose for the procedure, and a protocol to be executed based on the rule.

Global rules, body part rules, modality rules, and modality modifier rules are contraindication rules. In other words, if a contraindication rule is satisfied, then an associated procedure is not recommended, or recommended with a warning. Contraindication rules can either be absolute rules or relative rules. For example, an absolute contraindication rule is if a patient has pacemaker, then an MRI procedure is not shown as recommendation, or a warning is provided against a requested MRI procedure. In an example of a relative contraindication rule, if a patient has claustrophobia, then an MRI procedure may be shown as a recommendation and accompanied with a warning that the MRI may not be appropriate if the patient is severely claustrophobic. It can therefore be understood that absolute contraindication rules ensure that only appropriate procedures are recommended, and relative contraindication rules ensure that those procedures that may be inappropriate are recommended with a warning. The procedure rules are not contraindication rules, but rather recommend a procedure and provide an appropriateness rating (e.g. score, priority, and radiation dose).

It can be appreciated that a relative rule refers to rule that is not absolute and in some situations can fail, while other situations can pass. When processing rules, the rules engine 64 can continue if a relative rule fails. If at the end of the rules processing, the only failing rules that apply to the procedure were relative rules, then the engine 64 can return the procedure as a valid result but must indicate that the procedure has some relative rules that failed. When returning a procedure that had some relative rules that failed, it is important to return all the reference text for each relative rule that failed.

The rule expressions include combinations of healthcare data and logic operators 76 (e.g. greater than, equal to, less than, within the range, Boolean comparators, etc.).

It will be appreciated that any module or component exemplified herein that executes instructions or operations may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data, except transitory propagating signals per se. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the servers 2, 6 or the PC 10, the mobile device 12, and the laptop 14 or accessible or connectable thereto. Any application or module herein described may be implemented using computer readable/executable instructions or operations that may be stored or otherwise held by such computer readable media.

Details regarding the healthcare system, will now be discussed.

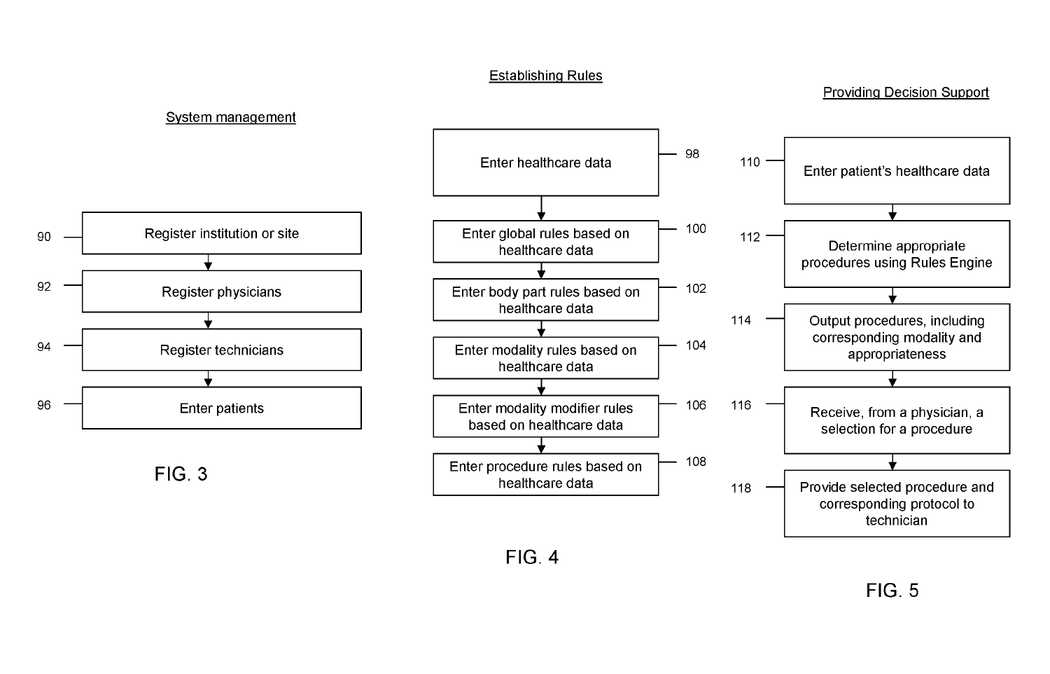

FIG. 3 provides example computer executable instructions for system management. An institution or site is register 90, followed by the associated physicians 92 and technicians 94. Then patient data is entered 96. Registration includes providing name, contact information, number of users, etc.

FIG. 4 provides example computer executable instructions for establishing rules. These instructions can take place at the management studio 62. At 98, healthcare data is entered into the system. At 100, global rules are entered based on the healthcare data 18. At 102, body part rules are entered. Similarly, modality rules are entered 104; modality modifier rules are entered 106; and procedure rules are entered 108.

FIG. 5 provides example computer executable instructions for providing decision support. These instructions can take place at the portal 60. At 110, a patient's healthcare data is entered. At 112, the appropriate procedures are determined based on the rules engine 64. At 114, the procedures are returned, including the corresponding modality and appropriateness. At 116, the system receives from a physician a selection for a procedure. At 118, the selected procedure and corresponding protocol are provided to a technician, for example, to carryout the procedure.

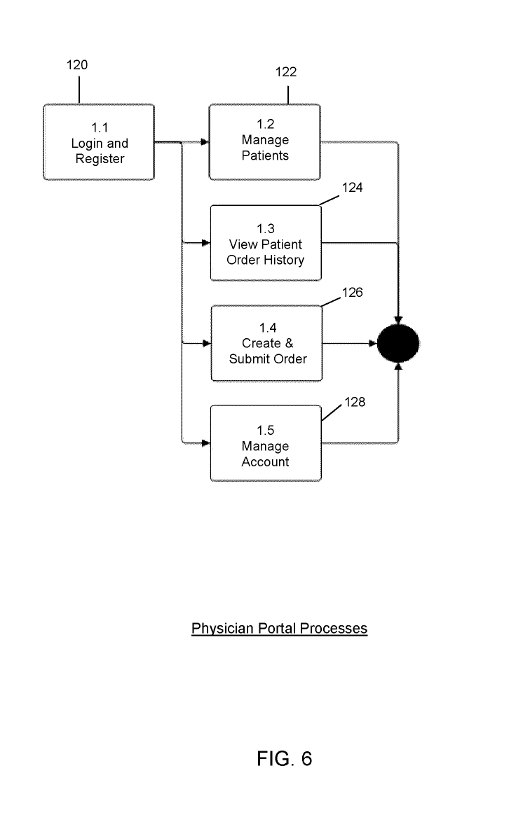

FIG. 6 provides example computer executable instructions for operations and processes taking place at the physician's portal. At 120, a user logs in and registers. Once access is gained to the healthcare system, the physician or physician's assistant can manage patients 122, view patient order history 124 (e.g. what tests and procedures were ordered in the past), create and submit new orders for tests and procedures 126, and manage the account 128.

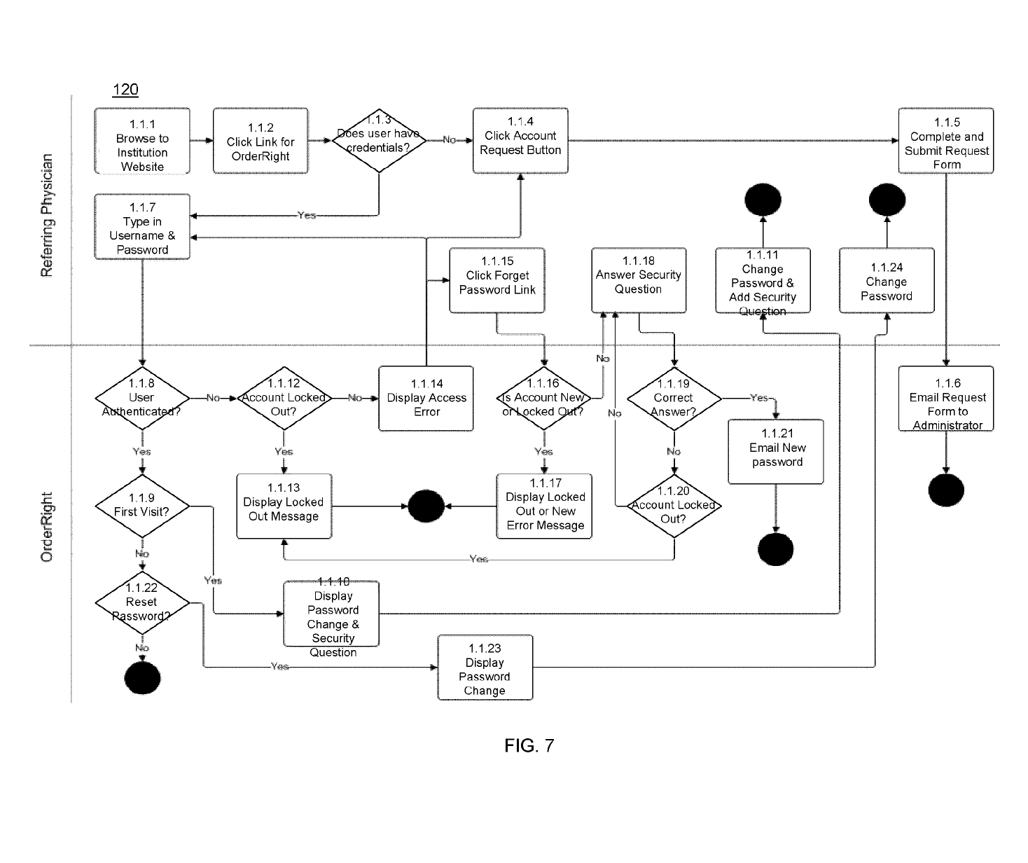

FIG. 7 provides example computer executable instructions for block 120. The physician provides a username and password if an account exists, or creates a new account. The healthcare system also provide security questions to reset or retrieve passwords for the user. It can be appreciated that other known methods for logging in and registering a user to a computer system are applicable to the principles described herein.

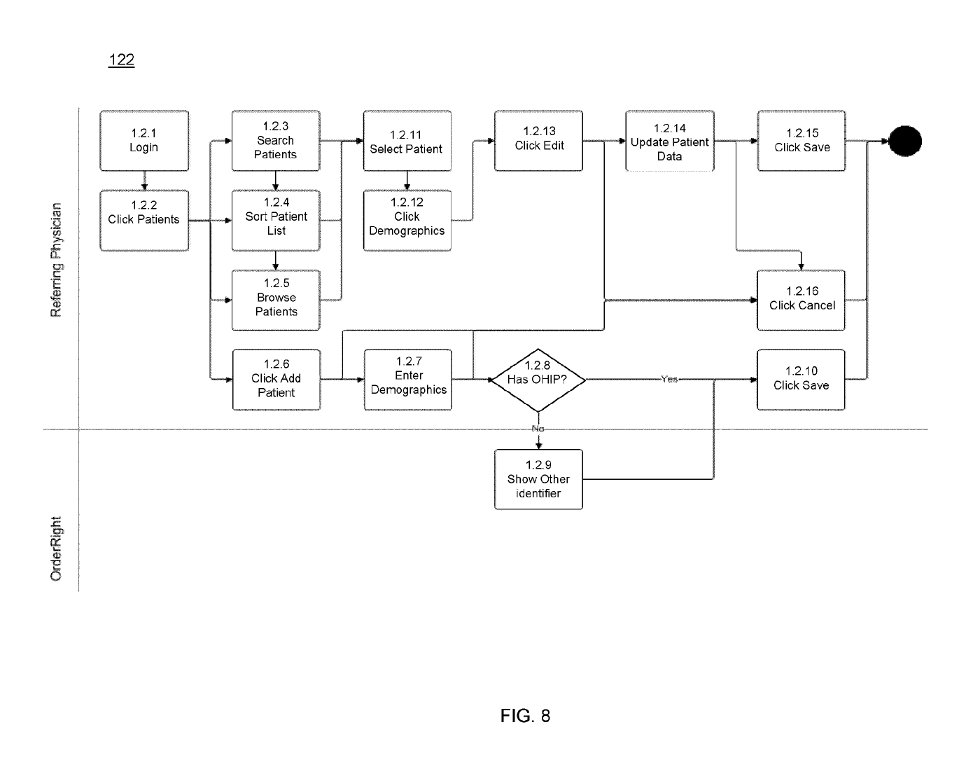

FIG. 8 provides example computer executable instructions for block 122. Patient data can be managed by searching, sorting and browsing patients. It can be appreciated that known methods for searching, sorting and browsing entries in a database can be used. When adding a new patient to the system, their name, gender, contact information, insurance information, patient consent, etc. can be included.

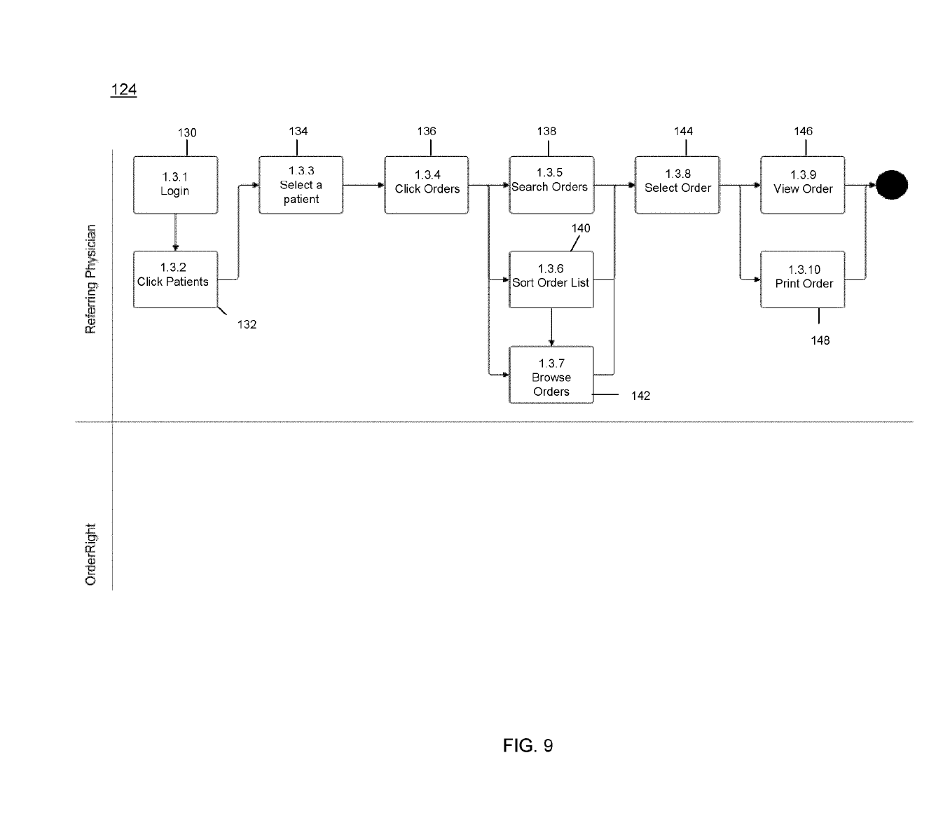

FIG. 9 provides example computer executable instructions for block 124. When viewing the patient order history, after logging into the system 130, a list of patients is provided 132. The system receives a selection for a particular patient 134, and then receives another input regarding the display of orders for past tests and procedures. The orders are displayed and controls are provided for searching 138, sorting 140 and browsing 142 the orders. The filtering, sorting, and display of the orders can be performed according to criteria, such as order date, modality, procedure, score, etc. At 144, an order is selected to display the order's details 146 or to print the same 148.

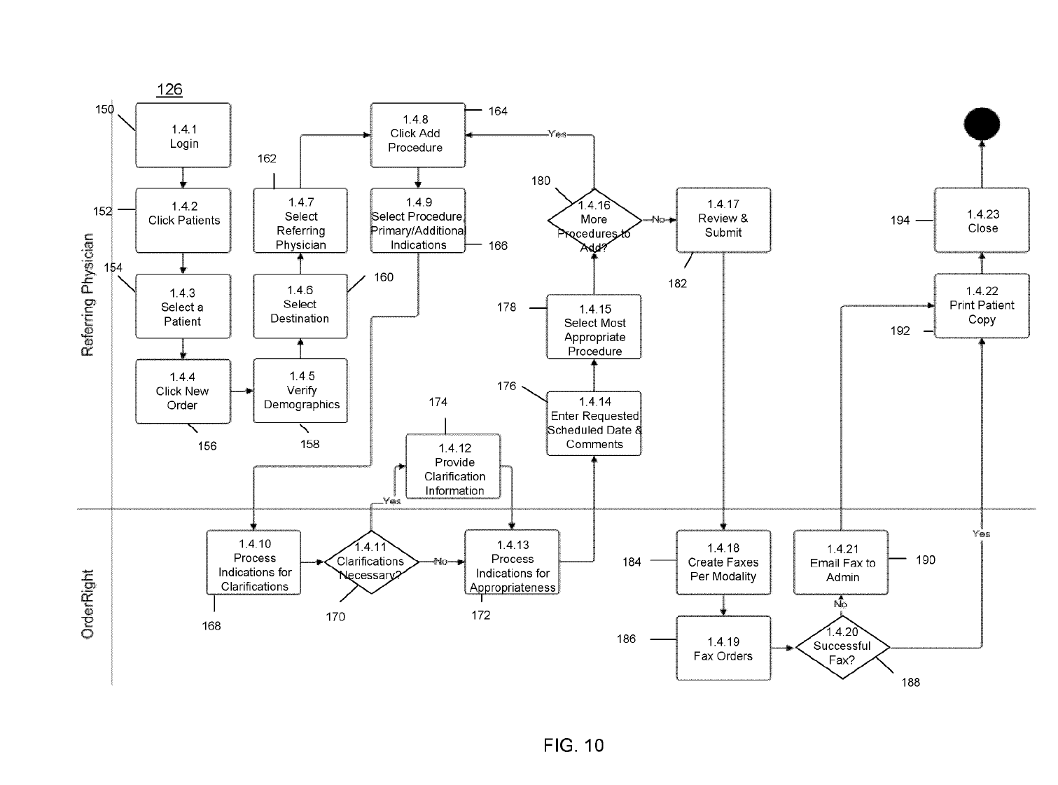

FIG. 10 also relates to FIG. 6, in particular block 126. Example computer executable instructions for creating and submitting orders for a patient. After logging in 150 and selecting a patient 152, 154, a new order is selected 156. At 158, the selected patient's demographics are presented to the physician for verification. If the verification is not successful, then the new order is cancelled. Otherwise, at 160 the destination or destinations (e.g. hospitals, institutes or sites where the tests or procedures are to be carried out) are selected. This may be chosen based on the vicinity of where the patient resides. At 162, the referring physician's is identified, either based on the physician's log in or based on a selection. At 164, an input is received to add a procedure. At 166, a procedure is selected from a list or procedures 38. Then, the primary indicators and additional indicators are entered or selected. At least one primary indicator is required to be selected. At 168, the healthcare system analyses the selected procedure and the indications to determine if an appropriateness score can be reached or if clarifications are required. At 170, it is determined if clarifications are necessary. If so, at 174, clarification information (e.g. questions regarding certain healthcare aspects) is presented to the user for their input. If not, or upon receiving the required clarification information, then at 172 the procedures and indications (and clarifications if provided) are processed to determine whether the selected procedure is appropriate using one or more rating systems. Results can include: returning a score for the requested procedure with recommendations; returning a score for the requested procedure without recommendations; returning only recommendations; and returning no score and no recommendations. At 176, the next available date for the requested procedure or a specific date selected date is scheduled for the requested procedure. Comments can also be provided for the procedure. At 178, the most appropriate procedure is selected. This decision rests with the physician, although is made much simpler as the most appropriate procedures are presented to the physician for selection. At 180, more procedures can be added. If no more procedures are added, then at 182 the requested order is submitted. At 184, a fax form for the order, or simply an order form, is create for the modality. The order form includes the patient's information, the physician's information, as well as the ordered date, the order placer or generator, the requested date, the modality, the procedure name, the primary indications, any additional indications and clarification indications, any protocols for the technician performing the procedure, the appropriateness score, the priority, the radiation dose and any additional comments. The order form is sent 186, e.g. to the institution performing the procedure and to the administrator 190. A copy of the order form is printed for the patient 192. The “new order” session on the healthcare system is then closed or completed 194.

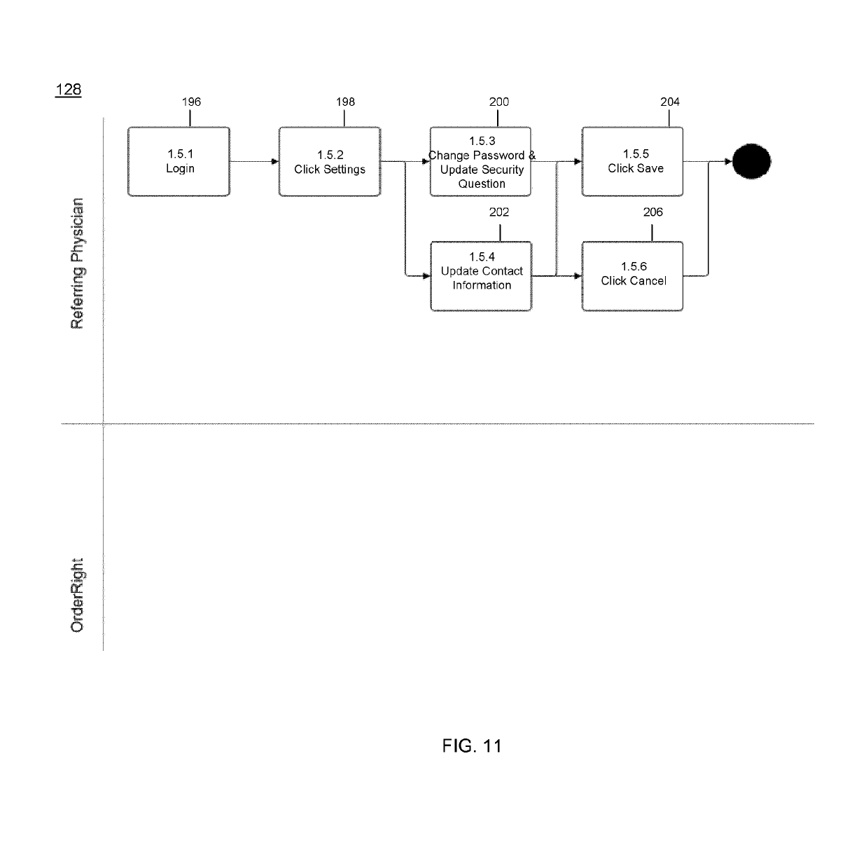

FIG. 11 provides example computer executable instructions for block 128, described earlier in FIG. 6. A user logs in 196, clicks the settings 198 and can change the password and security settings 200, or update contact information, or both 202. The changes can be saved 204 or discarded 206.

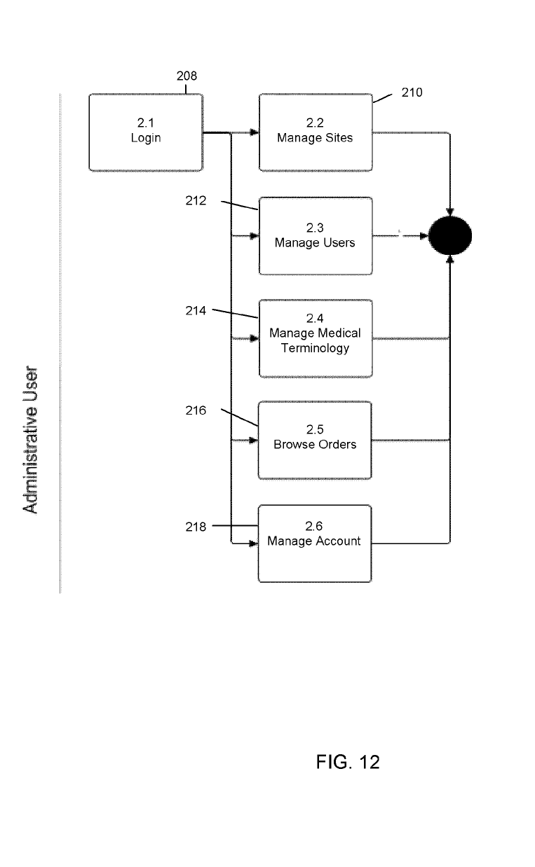

Turning to FIG. 12, example computer executable instructions are provided in relation to the management studio 62. At 208, the administrator logs in to the management studio 62, and from there is able to manage sites 210, manage users 212, manage medical terminology 214, browser orders 216, and manage accounts 218.

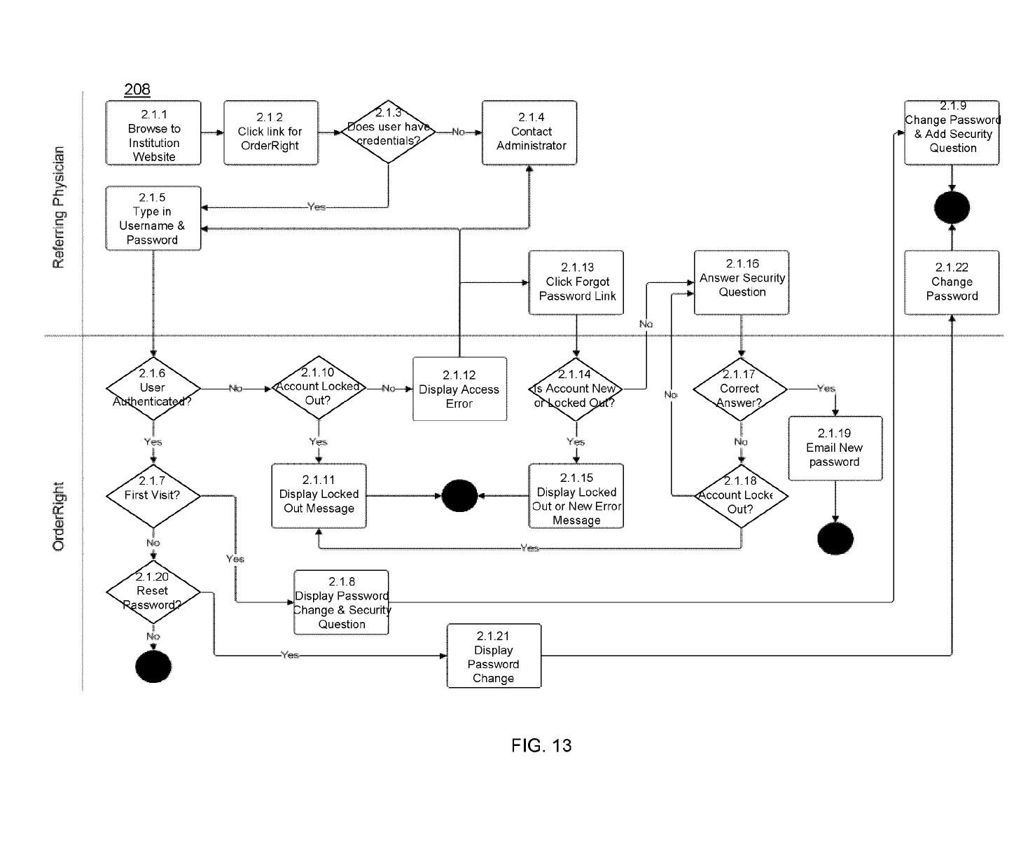

FIG. 13 provides example computer executable instructions for block 208. The methods for logging into a software system are known and can be applied here.

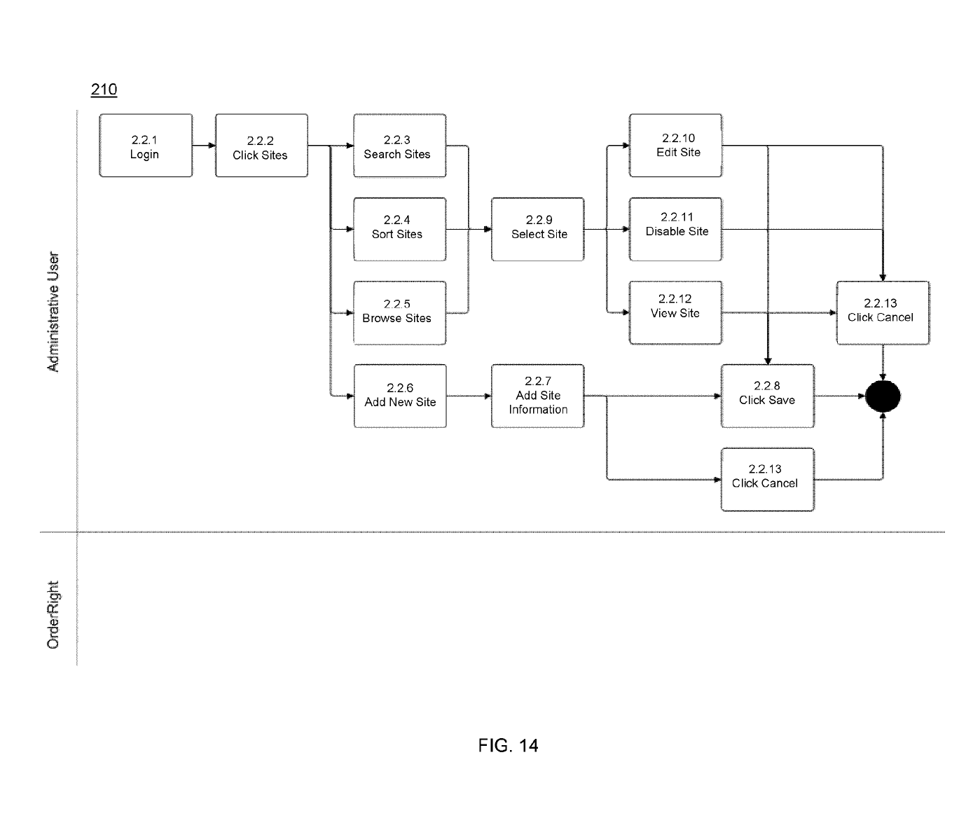

FIG. 14 provides example computer executable instructions for block 210. In particular, sites or accounts for an institution can be searched, sorted, and browsed. New sites can be added. Existing sites can be edited, disabled, or viewed.

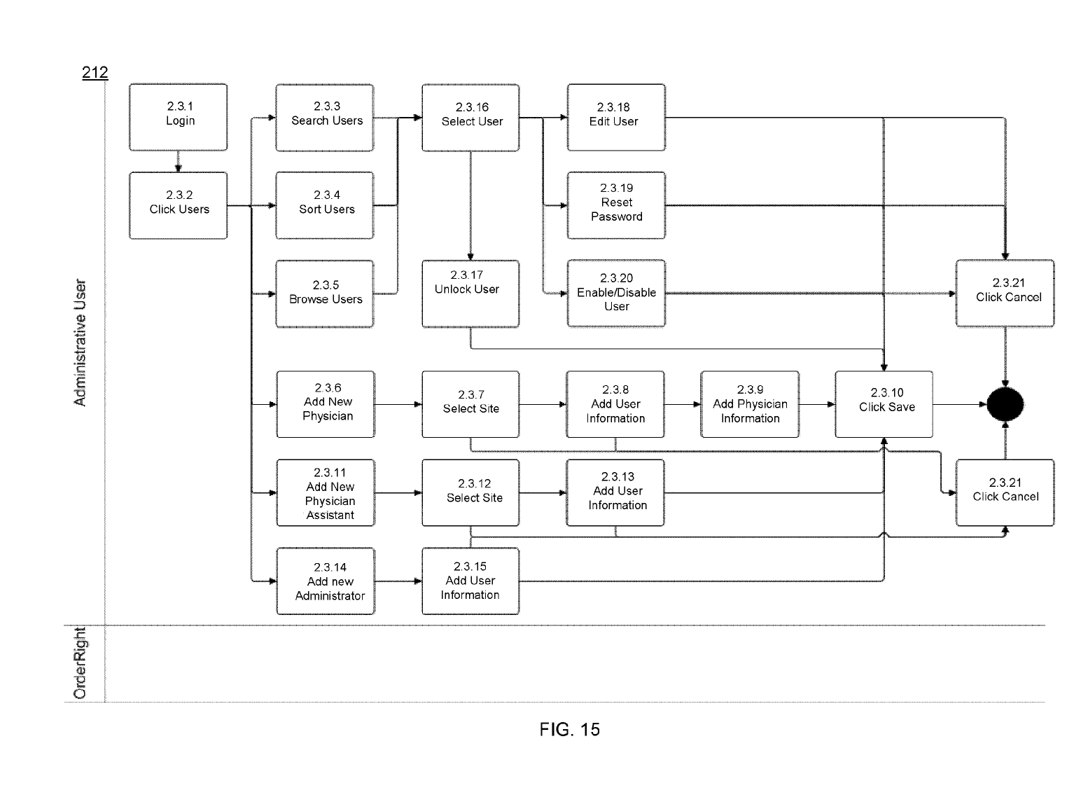

FIG. 15 provides example computer executable instructions for block 212. Users can be managed by searching, sorting and browsing existing users. User information can be edited, and their accounts can be enabled and disabled. New physicians, physician assistants, and administrators can be added. Usually the physician and physician administrator are associated with a site. Physician information can also include an image of their signature, their license number, and their billing number.

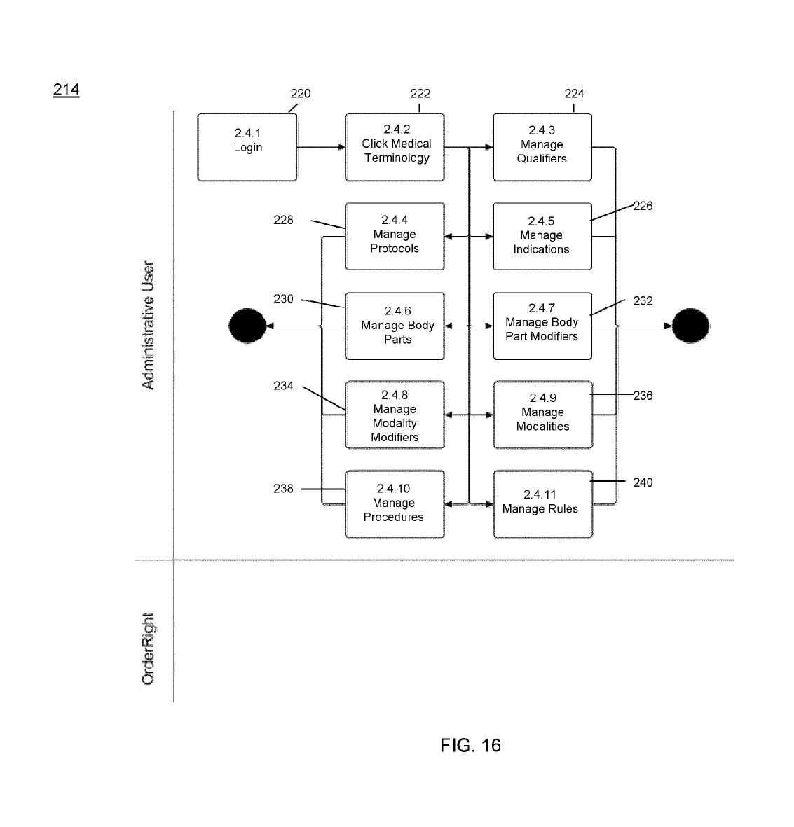

FIG. 16 provides example computer executable instructions for block 214, e.g. managing medical terminology. Upon logging into the healthcare system 220, and upon selecting the medical terminology control 222, controls or options are provided for managing qualifiers 224, managing indications 226, managing protocols 228, managing body parts 230, managing body part modifiers 232, managing modality modifiers 234, managing modalities 236, managing procedures 238, and managing rules 240.

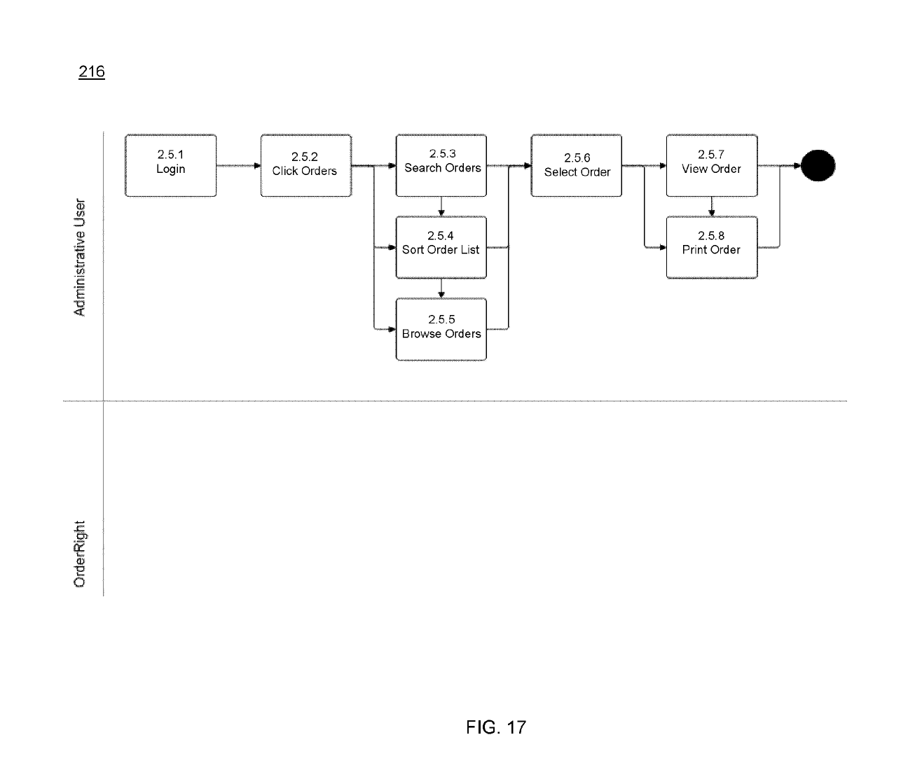

FIG. 17 provides example computer executable instructions for block 216. An administrator can search, sort and browse orders. This can be carried out using parameters, such as modality, procedure, patient name, insurance number, clinic name, physician name and ordered date.

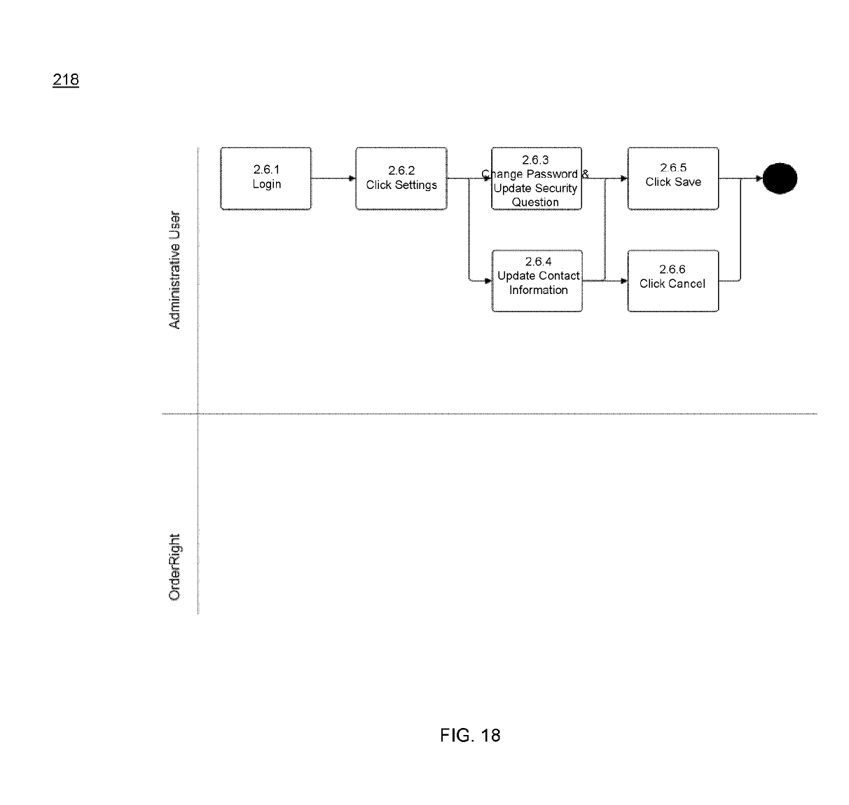

FIG. 18 provides example computer executable instructions for block 218, whereby an administrator can manage their own account. This includes changing their password, security information, and contact information.

Referring back to FIG. 16 and FIG. 2, it can be appreciated that the proposed systems and methods advantageously allow a user to create and manage healthcare rules based on the healthcare data. The following describes how the healthcare data is managed, as well as how the healthcare rules are created.

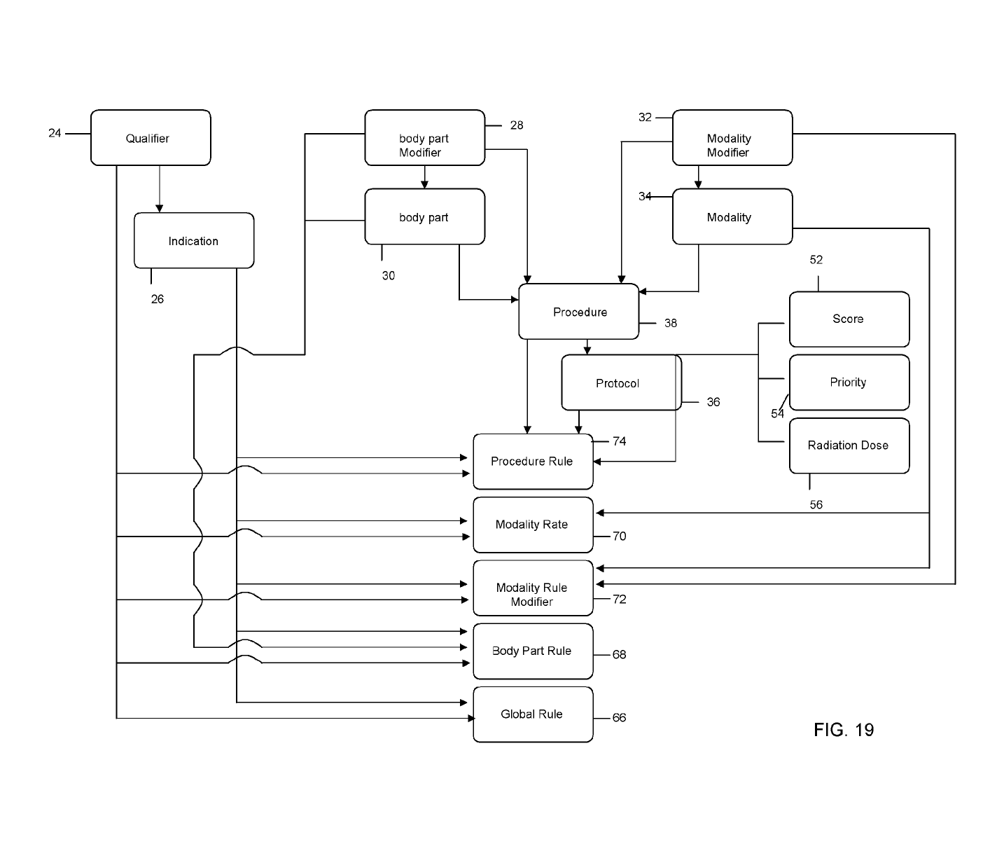

Turning to FIG. 19, an example configuration showing the relationships between data components in the healthcare database 18 is provided. Each instance of a qualifier 24, a body part modifier 28 and a modality modifier 32 does not depend from other data components. However, each instance of a body part 30 includes portions or instances of the body part modifier 28. Each instance of a modality 34 includes portions or instances of the modality modifier 32. Each instance of an indication 26 includes portions or instances of the qualifier 24, and may also include portions or instances of the body part 30. Each instance of a procedure 38 includes portions or instances of the body part 30, the body part modifier 28, the modality modifier 32, and the modality 34. Each instance of a protocol 36 includes an instance of a procedure 38.

Based on the above healthcare data, various rules can be generated. A procedure rule 74 includes an instance of a procedure 38, the associated protocol 36 (if any), a score 52, a priority 54 and a radiation dosage 56. A procedure rule also includes an instance of a qualifier 24 and an instance of an indication 26.

A modality rule 70 includes an instance of a qualifier 24 and an instance of an indication 26. A modality rule 70 also includes an instance of a modality 34.

A modality modifier rule 72 includes an instance of a qualifier 24 and an instance of an indication 26. A modality modifier rule 72 also includes an instance of a modality 34 and modality modifier 32.

A body part rule 68 includes an instance of a qualifier 24 and an instance of an indication 26. It also includes instances of a body part modifier 28 and body part 40.

A global rule 66 is not limited to any body part or modality. Rather, global rules 66, which include an instance of a qualifier 24 and an indication 26, apply to all procedures 38.

As described earlier, contraindication rules include global, modality, modality modifier and body part rules. Procedure rules 74 are not contraindication rules. In other words, if one of the contraindication rules is true or is applicable to a given scenario, then a warning message against using a certain procedure or modality appears.

It can therefore be appreciated that information is to be inputted or entered into the healthcare database 18 in a certain sequence in order to account for the information dependency. For example, the qualifiers, the body part modifiers and the modality modifiers should be inputted into the database 18 first. The body parts and the modalities should be added second. The indications and procedures should be added third. Upon entering in the healthcare data 18, the rules can be then be formulated based on the entered healthcare data 18.

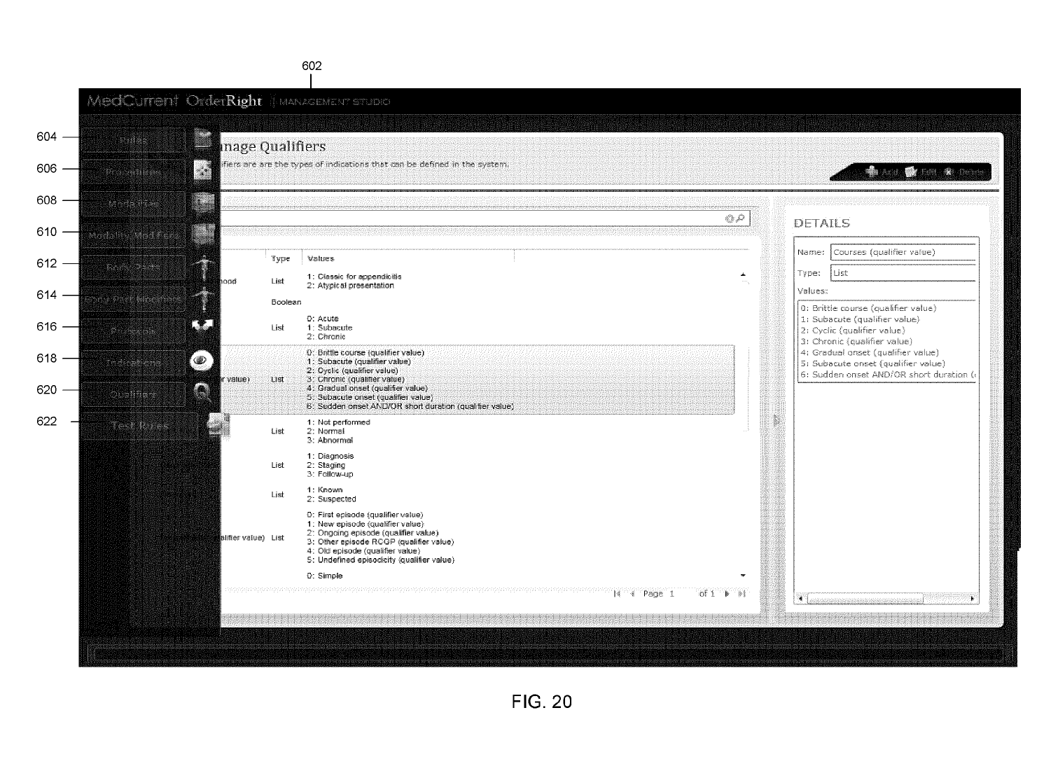

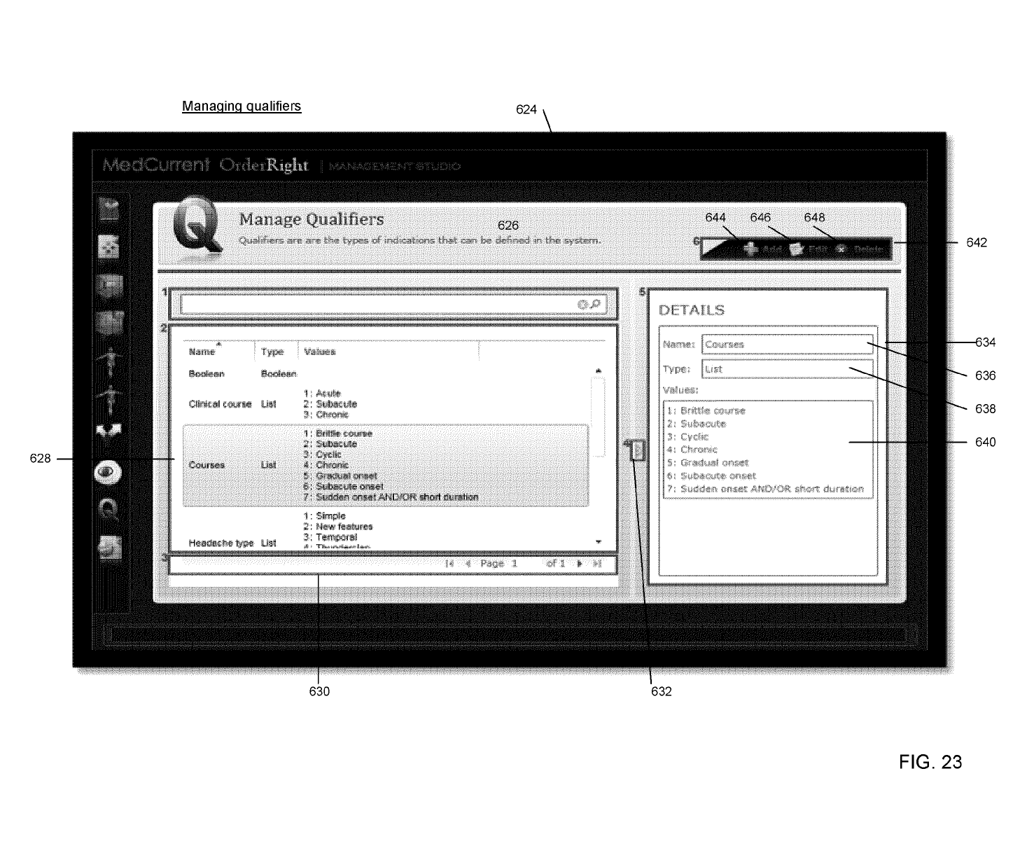

Turning to FIG. 20, a screenshot 602 of the management studio 62 of the healthcare system is provided. Tabs or interactive controls allow a user to manage different aspects of the management studio 62. The controls include a rules tab 604, a procedures tab 606, a modalities tab 698, a modality modifiers tab 610, a body parts tab 612, a body part modifiers tab 614, a protocols tab 616, an indications tab 618, a qualifiers tab 620 and a test rules tab 622. Upon the healthcare system detecting an input associated with these tabs or controls, a different screen or page will be displayed according to the selected tab or control. For example, upon receiving a selection input associated with the qualifiers tab 620 a manage qualifiers page appears, a screenshot 624 of which is shown in FIG. 23.

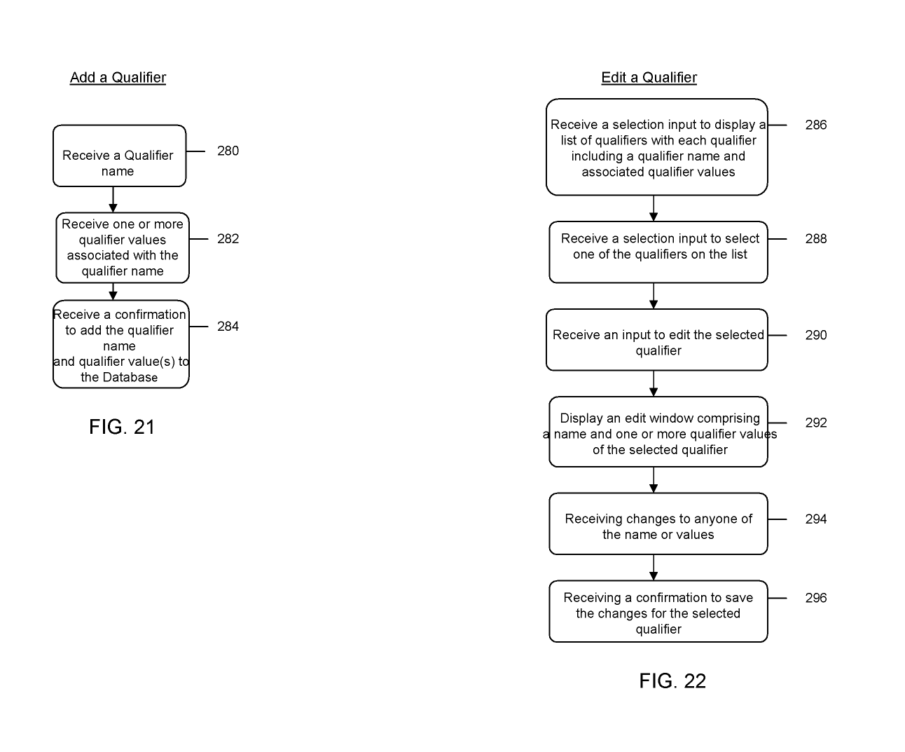

Turning to FIG. 21, example computer executable instructions are shown for adding a new qualifier to the healthcare database 18. The healthcare system receives a qualifier name (280), and then receives one or more qualifier values associated with the qualifier name (282). At 284, a confirmation to add the qualifier name and qualifier value or values to the database is received. For example, a qualifier name is “Appendicitis likelihood” and the one or more associated qualifier values are in a list including “classic for appendicitis” and “atypical presentation”. Each item in the list is associated with an integer to establish a numeric order. In another example, a qualifier name is “age” and one or more associated values may simply be any integer. In another example, a qualifier name is “Boolean” and it's associated qualifier value is a Boolean type (e.g. True or False).

FIG. 22 shows example computer executable instructions for editing an existing qualifier stored in the healthcare database 18. At 286, a selection input is received (e.g. from a user) to display a list of qualifiers, each qualifier including a qualifier name and one or more associated qualifier values. At 288, a selection input is received (e.g. from a user) to select one of the qualifiers on the list. At 290, an input is received to edit the selected qualifier. At 292, an edit window is displayed, whereby the edit window includes the name and the one or more qualifier values of the selected qualifier. At 294, changes are received to revise any one of the name or the values. Changes may also include modifying the order of the values, where the qualifier values are of the list type. At 296, a confirmation is received to save the changes for the selected qualifier.

Turning to FIG. 23, a screen shot 624 for managing qualifiers in the management studio 62. A search bar 626 is provided for searching the list of qualifiers currently stored in the healthcare database 18. For example, users can enter text in the search bar 626 and the management studio 62 will search for qualifiers based on the entered text. A list of qualifiers 628 is provided showing the name of the qualifier, the type of the qualifier (e.g. list, Boolean, integer), and the values associated with the qualifier. If there are many qualifiers or items in the list 628, the qualifiers may be separated across different pages. A paging control 630 provides controls to navigate the pages of the list. Details 634 of a selected qualifier in the list 628 can be shown or hidden using the control 632. When the details 634 are shown, they include the name of the selected qualifier 636, the type of the selected qualifier 638 and the values of the selected qualifier 640. The GUI also provides an action menu 642 which includes an add control 644 for adding a new qualifier, an edit control 646 for editing an existing qualifier, and a delete control 648 for deleting an existing qualifier. It can be appreciated that selecting the add control 644 initiates the computer executable instructions set forth in FIG. 21. Similarly, selecting the edit control initiates the computer executable instructions set forth in FIG. 22.

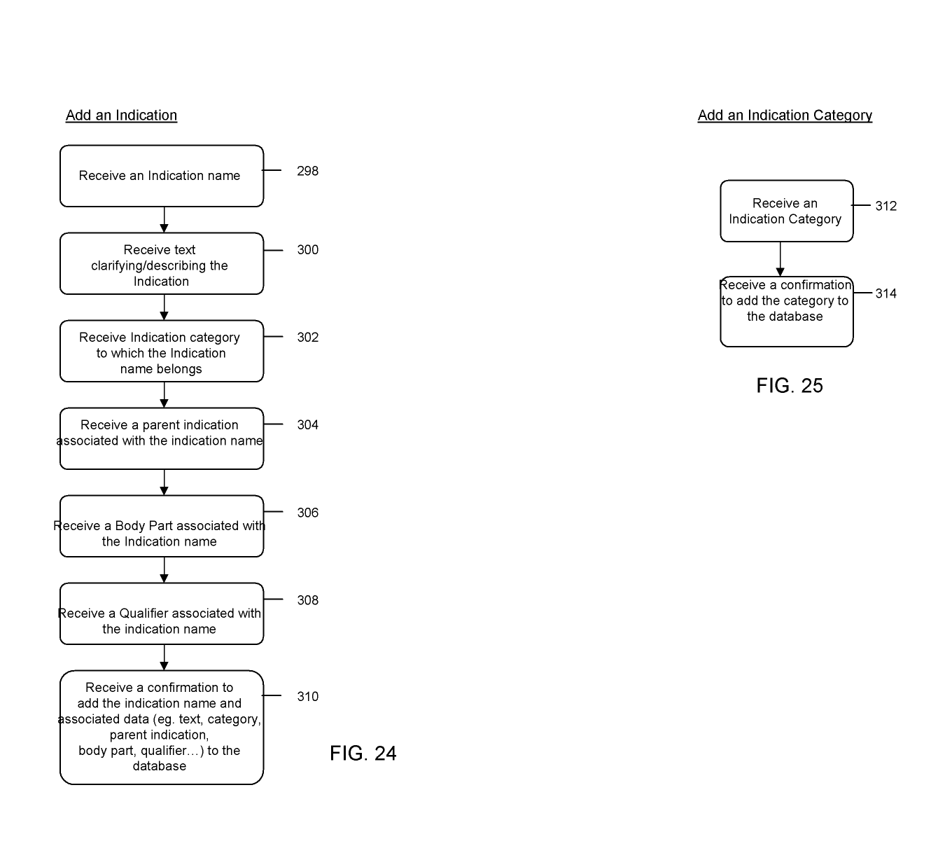

Turning to FIG. 24, example computer executable instructions are provided for adding an indication. At 298, an indication name is received. At 300, text (e.g. “help text”) that clarifies or describes the indication name is received. At 302, an indication category is received, whereby the indication name belongs to the indicate category. At 304, a parent indication is associated with the indication name. If a parent indication is provided, then it is considered that the indication name is a subset or the parent indication. At 306, a body part is received which is associated with the indication name. The body part is selected from a list of existing body part names stored within the healthcare database 18. At 308, a qualifier is received, whereby the qualifier is associated with the indication name. The qualifier is selected from a list of existing qualifiers stored in the healthcare database 18. For example, a indication name is “encephalitis” and is under the indication category “disease or condition”. It is associated with the “head” body part and is associated with the qualifier “Boolean”. In other words, a patient either does have encephalitis or does not. At 310, a confirmation is received to add the indication name and associated data (e.g. text, category, parent indication, body part, qualifier, etc.).

It can be appreciated that indication categories can be added to the healthcare database 18 beforehand or during the addition of the indication name. FIG. 25 shows example computer executable instructions for adding an indication category. Upon receiving a new indication category at 312, a confirmation to add the category to the database is received at 314.

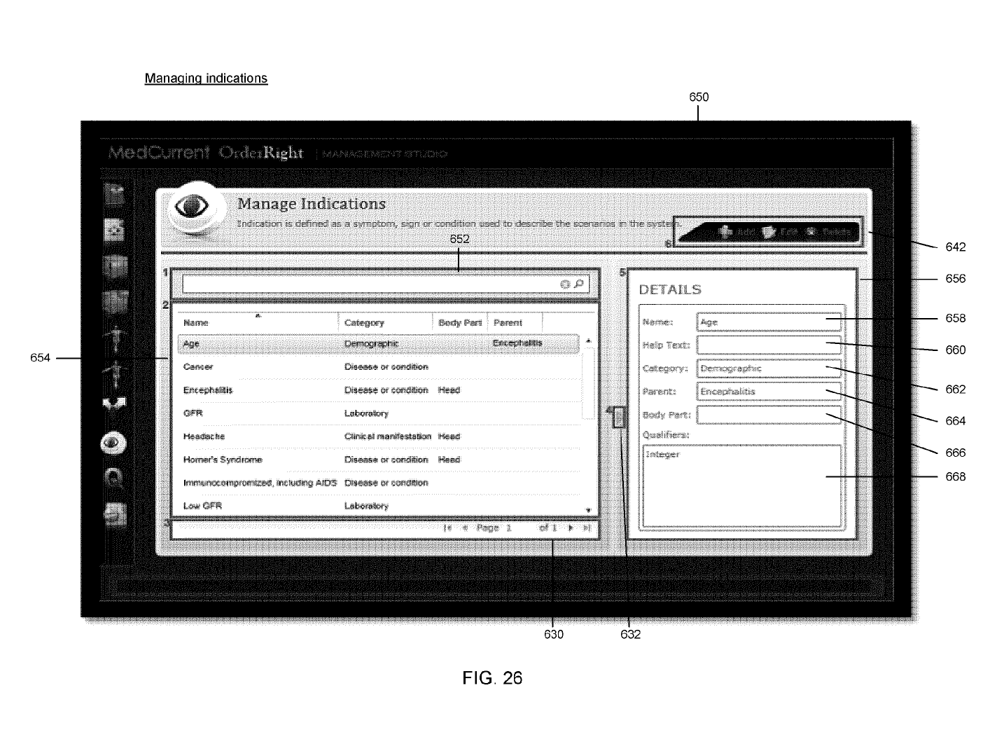

Turning to FIG. 26, a screenshot 650 of a GUI for managing indication is provided. Controls 630, 632 and 642 are described earlier, although such controls pertain to the indications data. The search bar 652 is used to search for existing indications. the list of indication 654 shows the name of each indication, as well as the associate category, body part and parent indication if applicable. Upon selecting a certain indication from the list 654, a details panel 656 will display the name 658, help text 660, the category 662, the parent indication 664, the body part 666 and the qualifier or qualifiers 668 that are associated with the certain indication.

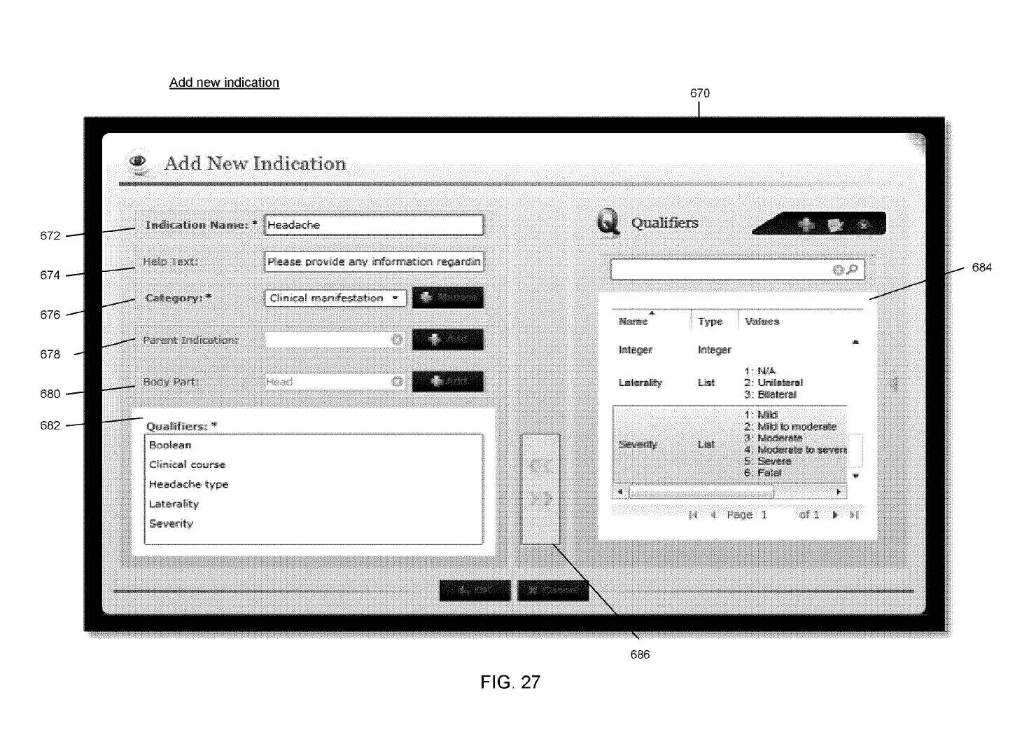

FIG. 27 shows an example screenshot 670 for adding a new indication. Various fields are shown, and those marked with an asterisk are considered to be required input data to create a new indication. An indication name 672 (required) may be “headache”. The help text 674 may be inputted to read “Please provide any information regarding how headache started”. The category 676 (required) reads “clinical manifestation”. The parent indication 678 is left unfilled. The body part 680 is a “head”. The qualifiers 682 associated with the new indication are selected from a list of existing qualifiers 684. The list of existing qualifier 684 shows the qualifier name, and the associated type and value or values. Selection may be facilitated by the control 686. The list of associated qualifiers 682 for the headache include Boolean, clinical course, headache type, laterality, and severity. Naturally, qualifier values may be associated with each the associated qualifiers.

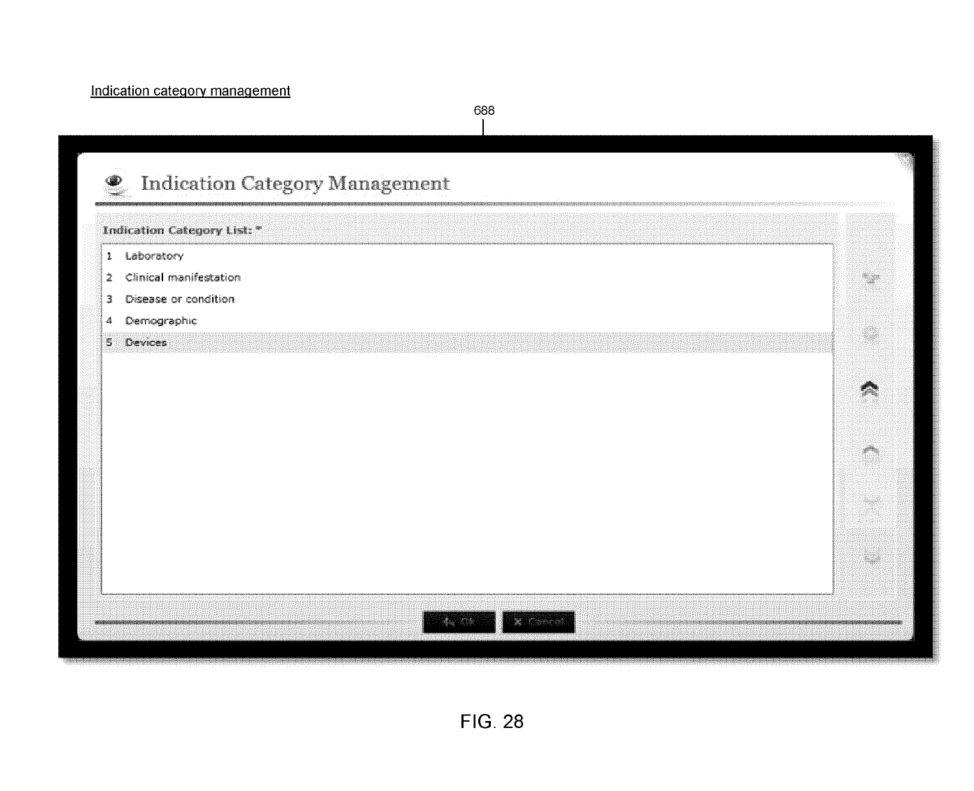

FIG. 28 show an example screenshot 688 of an indication category management GUI, in which the order of the categories can be rearranged.

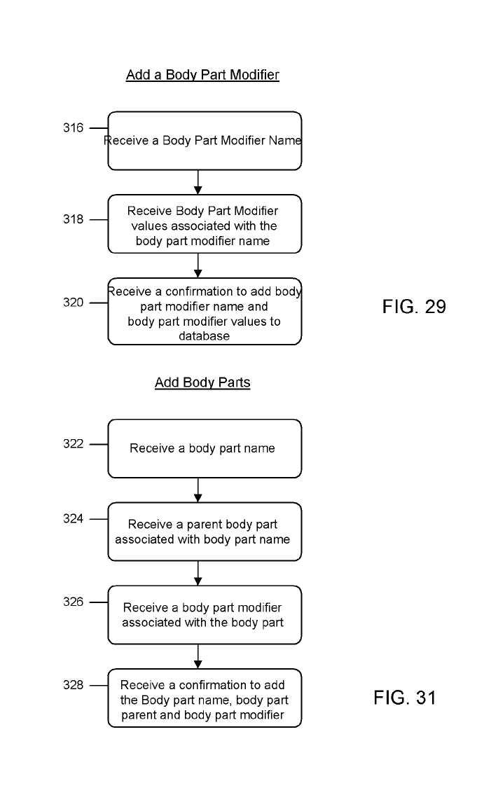

Turning to FIG. 29, example computer executable instructions are provided for adding a body part modifier to the healthcare database 18. A body part modifier name is received (316). One or more body part modifier values are then received, whereby the one or more values are associated with the body part modifier name (318). At 320, the management studio 62 receives a confirmation to add the body part modifier name and the body part modifier values to the healthcare database 18. Each of the body part modifier values are associated with an integer to maintain an order. It can be appreciated that the order of the body part modifier values can be rearranged. For example, a body part modifier name may be “side”, which indicates the side of the body. The values for the “side” include “left” and “right”, whereby “left” is associated with the number ‘0’ and “right” is associated with the number ‘1’.

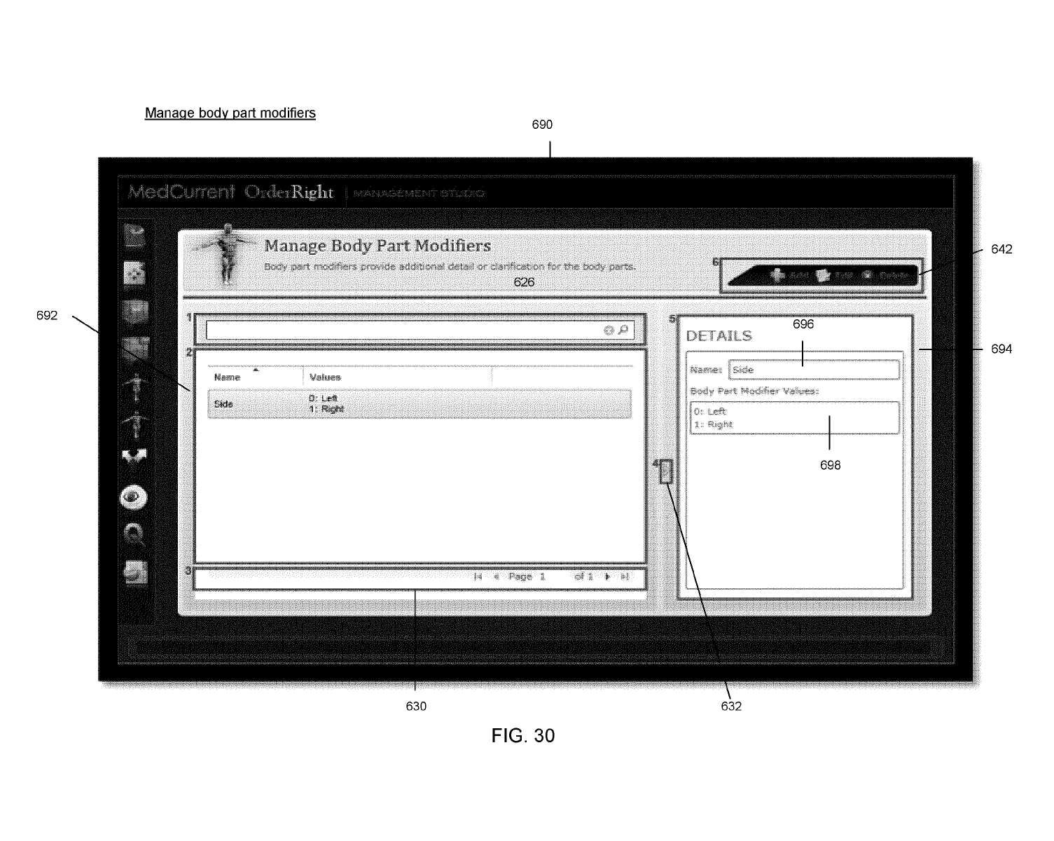

FIG. 30 shows an example screenshot 690 of a GUI in the management studio 62 for managing body part modifiers. Controls 626, 630, 632, and 642 are described earlier, although they now pertain to body part modifiers. The list of body part modifiers 692 shows the name of each modifier and the associated values. Similarly, the details of the selected body part modifier in the list 692 are shown in the details panel 694. The details panel 94 includes the name 696 and the associated body part modifier values 698.

Turning to FIG. 31, example computer executable instructions are provided for adding body parts to the healthcare database 18. At 322, the management studio 62 receives a body part name. At 324, a parent body part is received which is associated with the body part name. The body part name refers to a body part that is part of or connected to the parent body part. For example, a finger is a body part that is part of or is connected to the hand (e.g. the parent body part). At 326, a body part modifier is received which is associated with the body part name. The body part modifier is selected from an existing list of body part modifiers that are stored in the healthcare database 18. At 328, the management studio 18 receives a confirmation to add the body part name and the associated body part parent and body part modifier to the healthcare database 18.

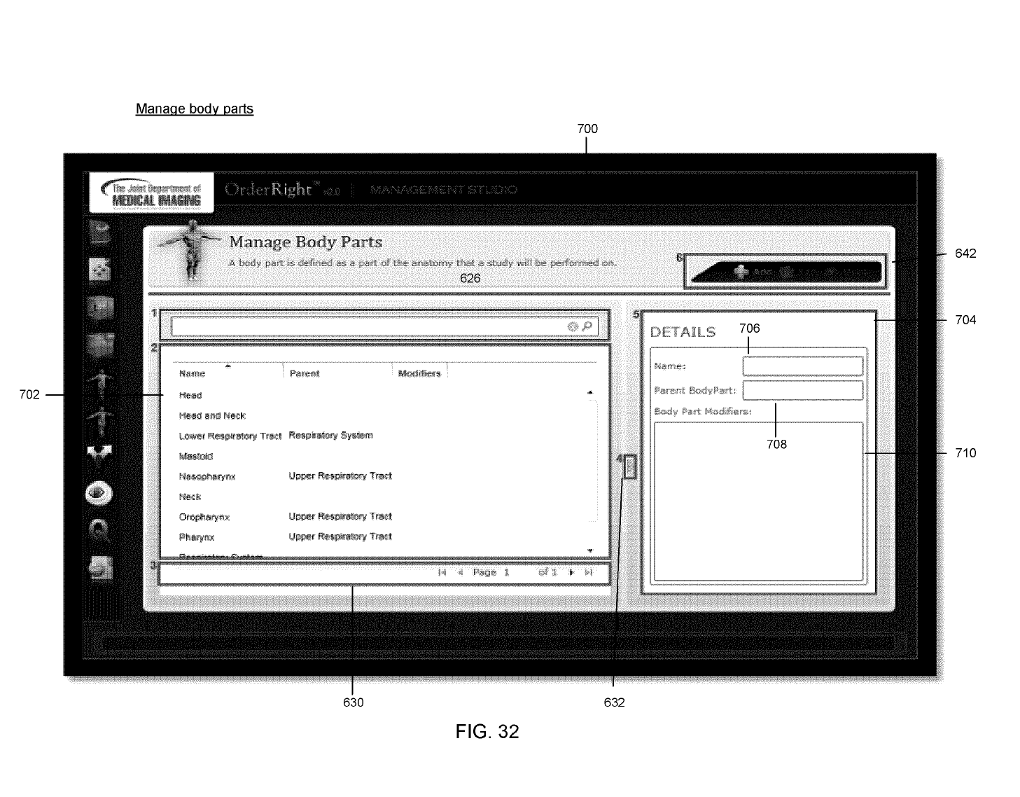

FIG. 32 shows an example screenshot 700 of a GUI for managing body parts in the management studio 62. A list of body part names are shown, whereby each body part name can be associated with a body part parent and a modifier. Selection of a body part in the list will also display associated details in the details panel 704. In particular, the details panel 704 shows the name 704, parent body part 708 and any body part modifier 710.

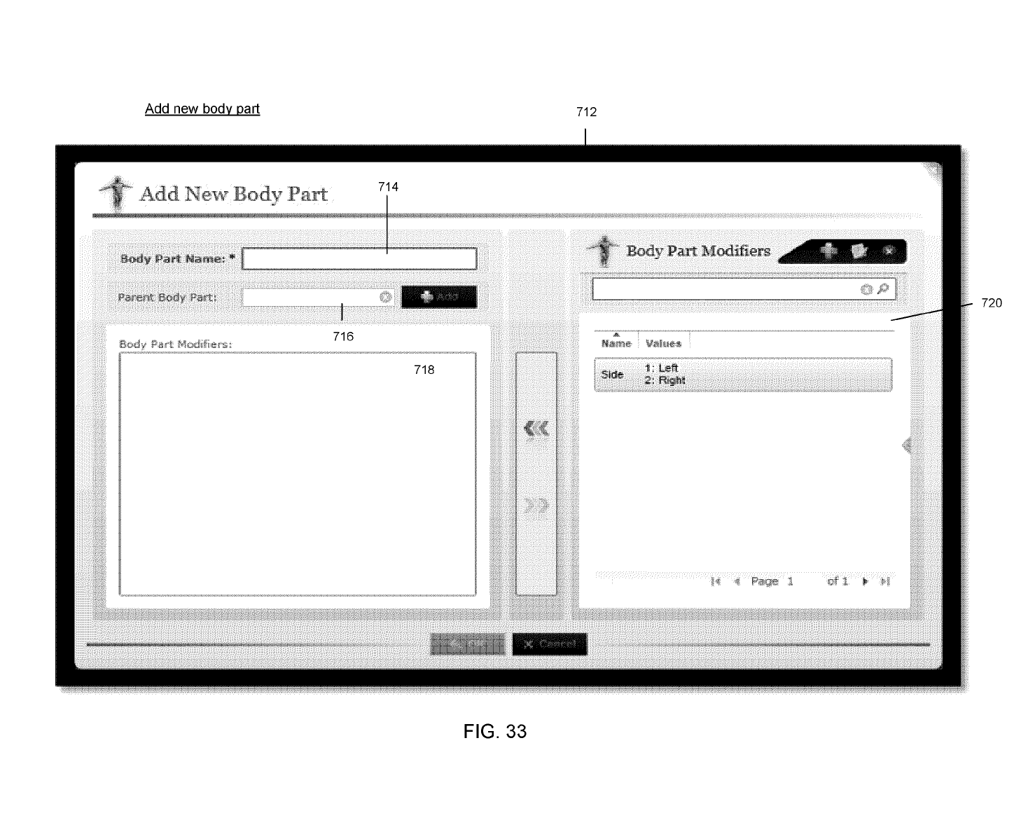

FIG. 33 shows an example screenshot 712 of a GUI for adding a new body part. This GUI can be displayed using the controls 642 in the screenshot 700. The screenshot 712 includes a text field 714 for receiving a body part name. A text field 716 allows a user to enter or select a parent body part. The body part modifiers panel 720 allows a user to browse and search for body part modifiers and the associated body part modifier values. A body part modifier from the panel 720 can be selected and associated with the new body part name 714.

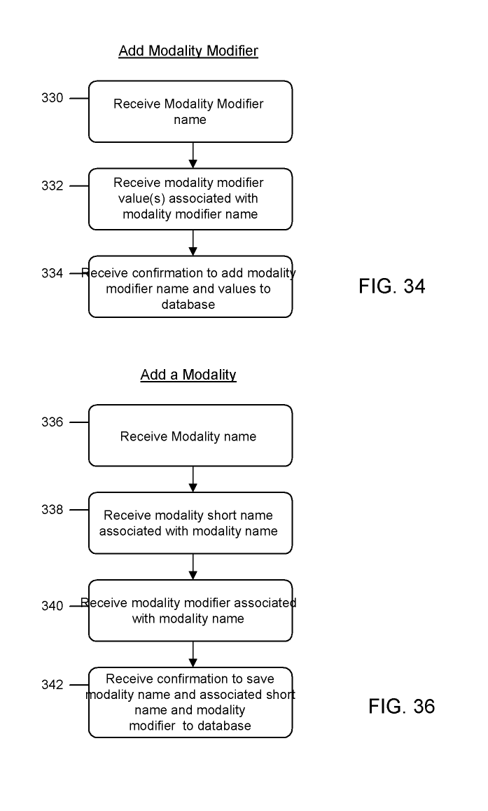

Turning to FIG. 34, example computer executable instructions are provided for adding a modality modifier. At 330, a modality modifier name is received by the management studio 62. At 332, a modality modifier value or values are received, which are associated with the modality modifier name. At 334, the management studio 62 receives confirmation to add the modality modifier name and values to the healthcare database 18.

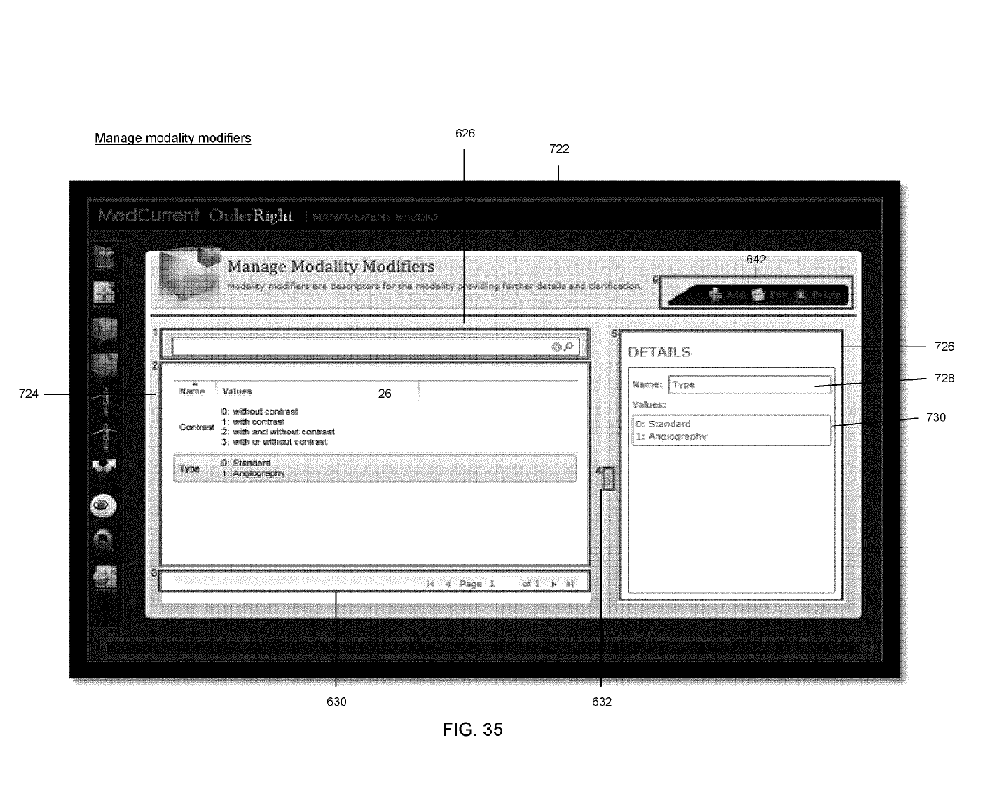

FIG. 35 shows a screenshot 722 of a GUI for managing modality modifiers as part of the management studio 62. The list 724 shows names of modality modifier names and their associated values. Selection of a certain modality modifier name displays the associated details in the details panel 726. The panel 726 displays the name 728 and the one or more values 730 of the modality modifier. Each value is associated with a number. For example, a modality modifier name may be a “contrast” and the values include: “without contrast” (associated with ‘0’); “with contrast” (associated with ‘1’); “with and without contrast” (associated with ‘2’); and “with or without contrast” (associated with ‘3’).

Turning to FIG. 36, example computer executable instructions are provided for adding a modality. At 336, a modality name is received. At 338, the management studio 62 receives a modality short name associated with the modality name. It can be appreciated that the modality short name may be identical to the long name, or may be different. The short name is merely a convenient reference. At 340, a modality modifier is selected or received and is associated with the modality name. The modality modifier is selected from a list of existing modality modifiers that are stored in the healthcare database 18. At 342, the management studio 62 receives confirmation to save the modality name and the associated modality modifiers in the healthcare database 18.

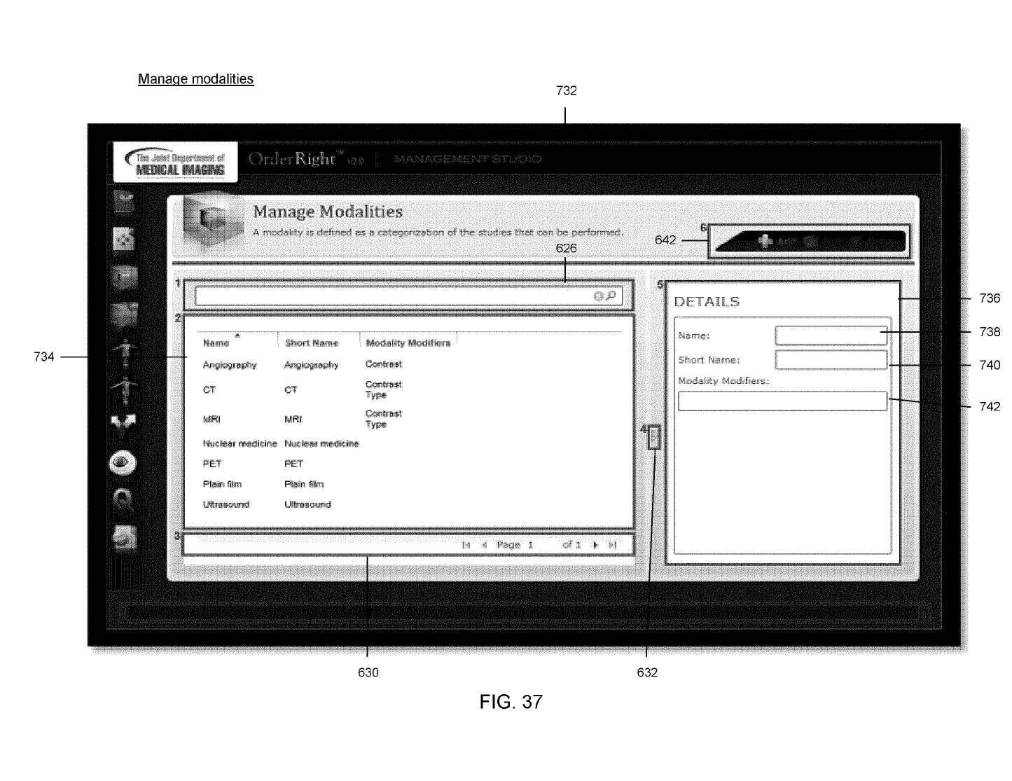

FIG. 37 shows an example screenshot 732 of a GUI for managing modalities in the management studio 62. The list 734 shows the names of modalities, as well as the short name and modality modifiers (if any) associated with each modality name. Selection of a certain modality in the list 734 will display details in the details panel 736. Details include the name 738, the short name 740, and any modality modifiers associated with the selected modality.

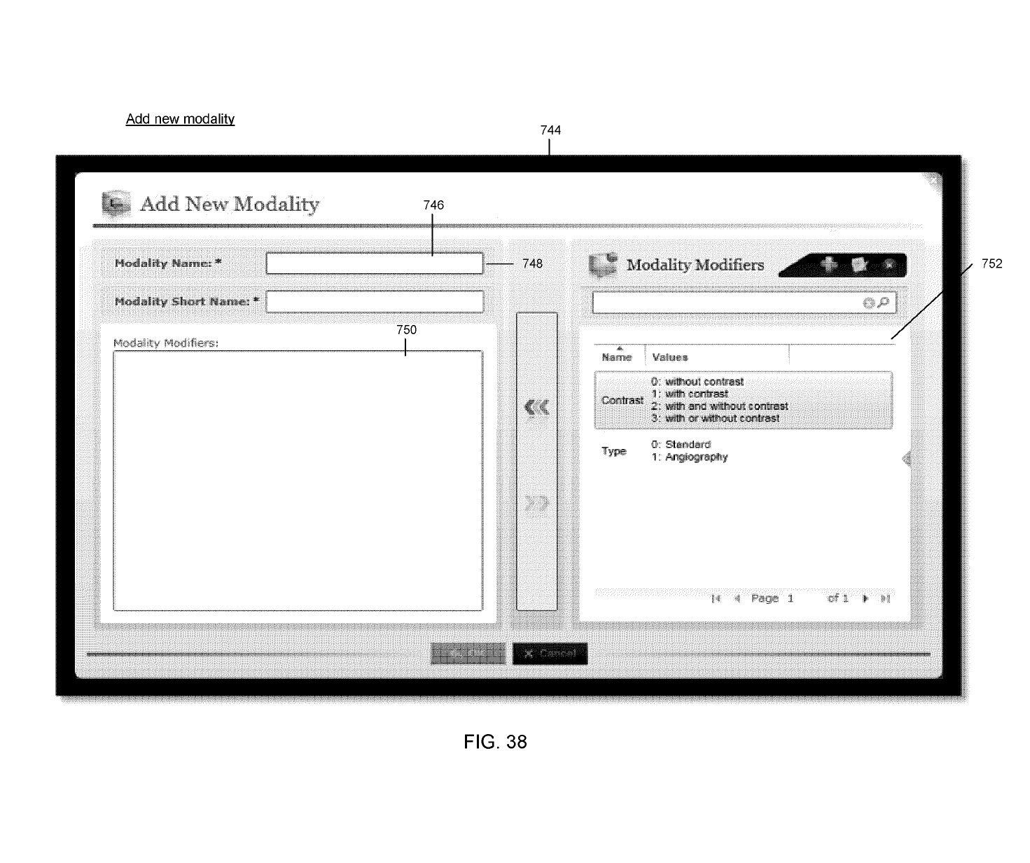

FIG. 38 shows and example screenshot 744 of a GUI for adding a new modality. Screenshot 744 can be displayed upon selecting a control from the panel 642 in screenshot 732. The screenshot 744 includes a text field 746 for adding a modality name and a text field 748 for adding a modality short name. Both inputs are required to add a new modality. A listing of associated modality modifiers 750 is also included. To populate the listing 750, a user can browse and search for existing modality modifiers in panel 752. An existing modality modifier can then be selected and associated with the modality name.

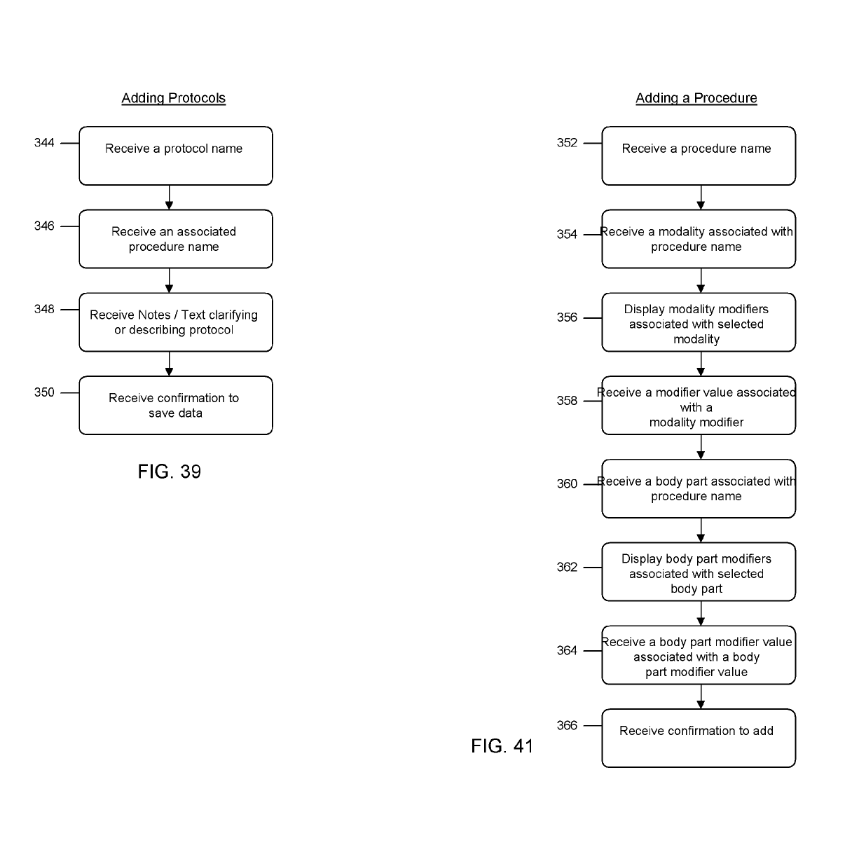

Turning to FIG. 39, example computer executable instructions are provided for adding protocols. At 344, the management studio 62 receives a protocol name. At 346, an procedure name is received. The procedure name is selected from a list of existing procedures stored in the healthcare database 18, and the selected procedure name is associated with the protocol name. At 348, text for clarifying or describing the protocol are received. At 350, the management studio 62 receives confirmation to save the protocol name and associated procedure name and clarifying text.

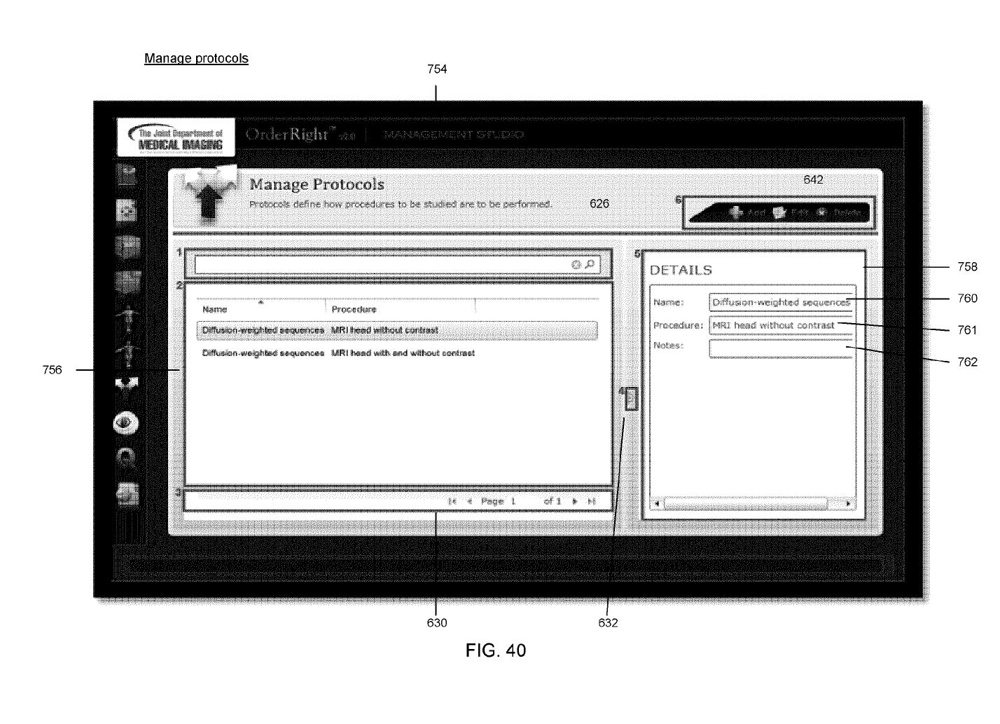

FIG. 40 shows an example screen shot 754 of a GUI for managing protocols as part of the management studio 62. A list of protocols 756 includes protocol names and the associated procedure. Details of a selected protocol name are also shown in the details panel 758. The panel 758 shows the name 760, the procedure 761 and any text or notes 762 describing the protocol.

Turning to FIG. 41, example computer executable instructions are provided for adding a procedure. At 352, the management studio 62 receives a procedure name. At 354, the management studio 62 receives a modality name associated with the procedure name. The modality name is selected from a list of existing modalities previously entered into the healthcare database 18. At 356, modality modifiers are displayed and are associated with the selected modality. Similarly, the modality modifiers are selected from a list that is stored in the healthcare database 18. The modality modifiers displayed are those that are associated with the selected modality name. At 358, a modality modifier value is received (e.g. selected from a list stored in the healthcare database 18), whereby the modality modifier value is associated with the selected modality modifier. At 360, a body part is received. The body part is selected from a list stored in the healthcare database 18 and is associated with the procedure. At 362, upon selecting the body part name, the management studio 62 displays a list of body part modifiers associated with the selected body part. At 364, a body part modifier value is received (e.g. selected from a stored list), whereby the body part modifier value is associated with the displayed body part modifiers. At 366, the management studio 62 receives a confirmation to add the procedure and the associated information to the healthcare database 18.

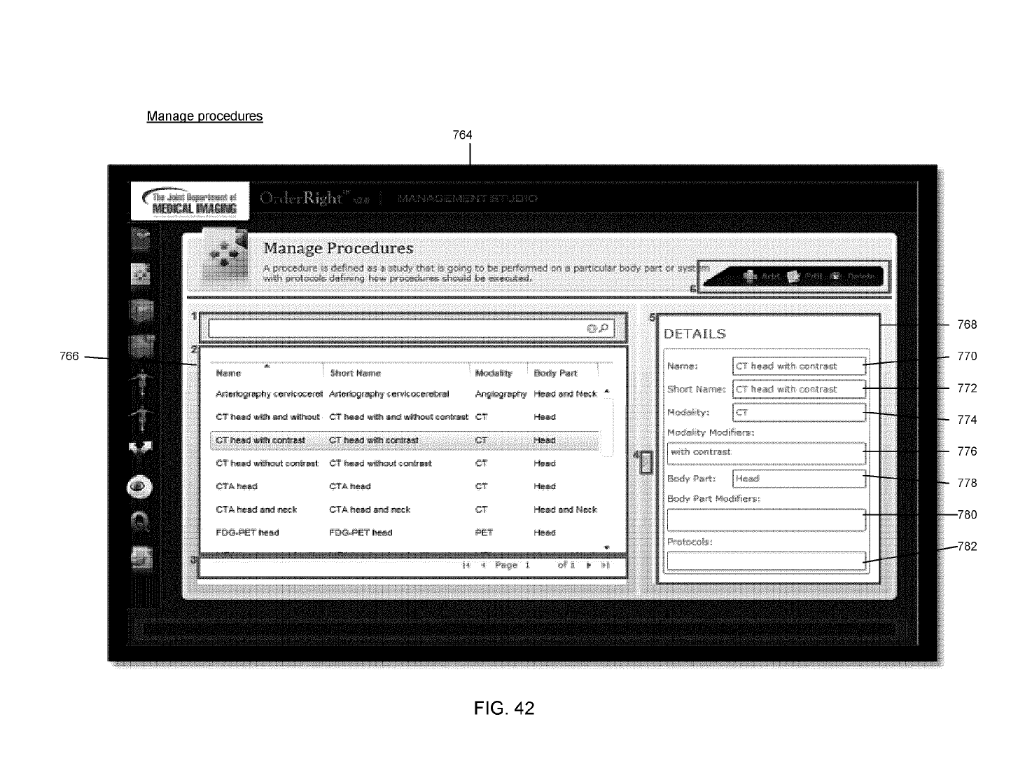

FIG. 42 shows an example screenshot 764 of a GUI for managing procedures in the management studio 62. It also shows an example of a procedure name that has been added (e.g. “CT heat with contrast”). The associated modality is “CT” having the modality modifier “with contrast”. The procedure is associated with the “head”, and no body part modifiers or protocols are associated with the procedure. The listing 766 of the procedure names are shown with their associated short names, modalities and body parts. Selection of a particular procedure name shows further details in the details panel 768. The panel 768 shows the name 770, the short name 772 and the associated data (e.g. modality 774, modality modifiers 776, body part 778, body part modifiers 780, and protocols 782).

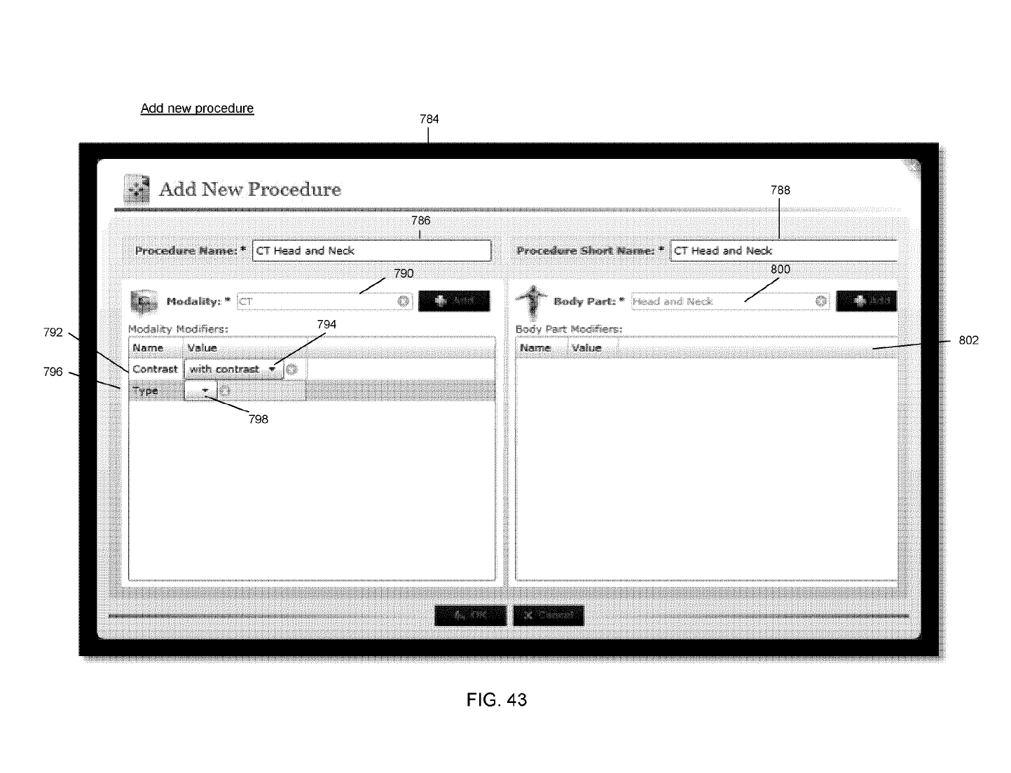

FIG. 43 shown an example screenshot 784 for adding a new procedure. Mandatory or required data inputs are marked with an asterisk and include the procedure name 786, the procedure short name 788, the modality 790 and the body part 800. In the example, the modality is “CT” and the listing of modality modifiers that are associated with the modality (e.g. “contrast” 792 and “type” 796) are automatically displayed. A user then uses controls 794 and 798 to select the contrast modifier value and the type modifier value, respectively. Listing 802 also displays any body part modifiers associated with the selected body part (e.g. “head and neck”), if any.

As described above, the sequence of how the information or data is entered is important, since certain data components depend from other data components. The above describes entering various healthcare data. Upon entering the healthcare data, a user can then formulate various types of rules which include the healthcare data. It can therefore be understood that the management studio 62 provides a flexible and convenient tool that allows a user to author or create complex healthcare decision support rules.

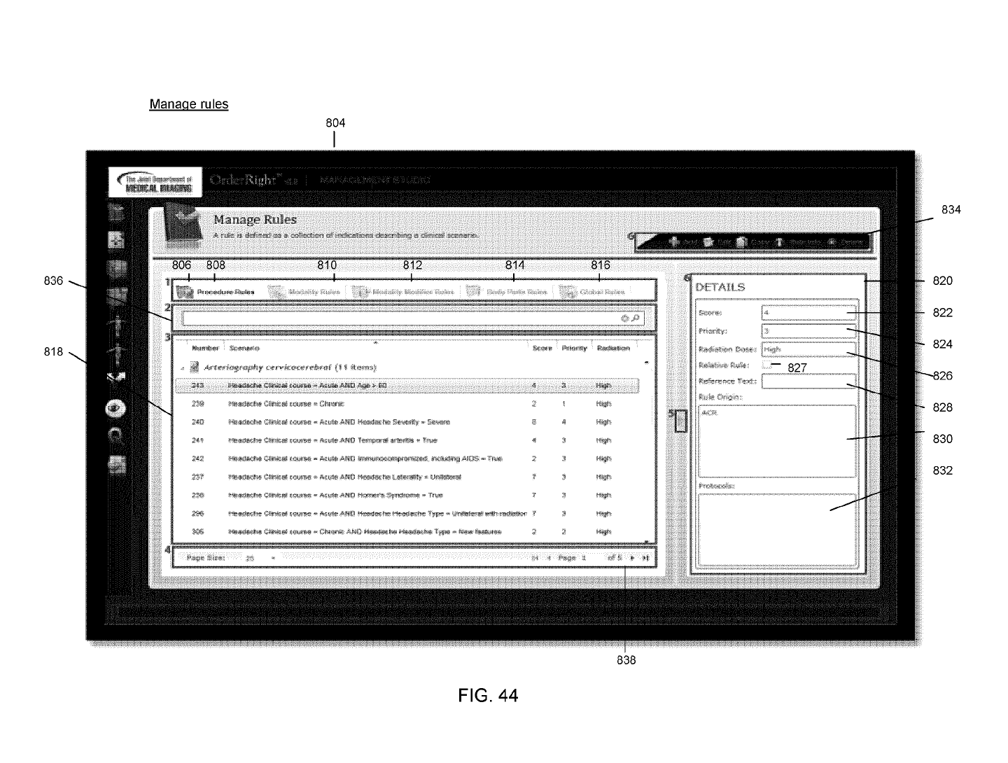

Turning to FIG. 44, an example screenshot 804 of a GUI for managing rules in the management studio 62 is provided. A series of tabs 806 provides a control that allows a user to select the type of rule to manage (e.g. create, edit, modify, copy, etc.). Selection of any one of a procedures tab 808, a modality rules tab 810, a modality modifier rules tab 812, a body part rules tab 814, and a global rules tab 816 will display the procedure rules, the modality rules, the modality modifier rules, the body part rules and the global rules, respectively. Selection of a particular rules tab will also allow a user to mange the selected type of rules. In the screenshot 804, the procedure rules tab 808 is selected. Therefore the action menu 834 has controls for adding, editing, copying and changing rule information for procedure rules. Search bar 836 allows a user to search or browse for existing procedure rules, which are shown in the rules listing 818. The listing 818 shows the number ID associated with each rule, the scenario of the procedure rule (e.g. the rule parameters), and the associated score, priority and radiation dosage for determining appropriateness of the procedure. Paging control 838 also allows the user to browse through the rules. The details panel 820 displays details associated with a selected one of the rules in the listing 818. The details panel 820 for the procedure rules includes the appropriateness rating (e.g. score 822, priority 824, radiation dose 826, whether the rule is a relative rule or not 827, reference text 828, rule origin 830 and associated protocols 832.

To provide a better understanding of the rules, a general overview of their structure is provided. The structure described below applies to the different types of rules (e.g. procedure rules, modality rules, modality modifier rules, body part rules, and global rules).

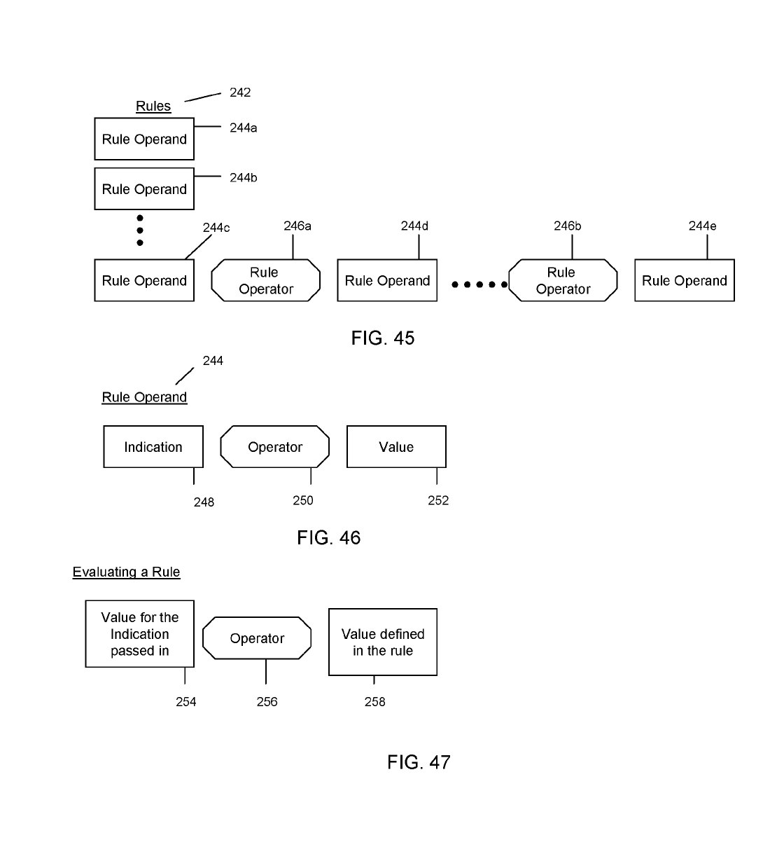

Turning to FIG. 45, a number of rule expressions 242 are provided. One rule expression is based on a rule operand 244a, while another rule is based on a different rule operand 244b. Rule operands may be generally referenced with numeral 244. Rule expressions can include combinations of rule operands 244c,d,e separated by rule operators 246a,b. Ruler operators can include “AND” logic, “OR” logic, “XOR” logic, “NOR” logic, “NAND” logic, etc.

At FIG. 46, a rule operand 244 is an expression relating an indication 248 to a value 242 through an operator 250. The value 242 can be an integer, Boolean, string, or character type value, for example. The operator logic relating the indication 248 to the value 242 include equal, not equal, greater than, greater than or equal, less than, less than or equal, not equal, etc.

FIG. 47 provides an expression for evaluating a rule. When evaluating a rule, each rule operand 244 in a multi rule-operand expression is evaluated. To evaluate each rule operand 244, the value for the indication passed in 254 is evaluated against the value 258 defined in the rule operand using the operator 256. The operator 256 is a comparator that determines whether the value of the indication passed in 254 is equal or not equal to the value 258.

In a Boolean rule example, a rule can be defined as “Headache=True”, whereby headache is the indication, “=” is the operator, the Boolean value is “false” or 0. Therefore, when evaluating this rule, if the indication value passed in is “headache=true”, and since the passed in value “true” equals the rule defined value of “True”, then the result with return a true value.

In a listing rule example, a headache indication can have one of the following values: mild, mild to moderate, moderate, moderate to severe, and severe. If a rule is defined as “Headache>Mild to Moderate”, then the indication is “Headache”, the operator is “>”, and the defined value is “Mild to Moderate”. The indication of the patient passed in to the system is headache, having a value of “severe”. The expression “severe>Mild to Moderate” is then evaluated, which returns a true value. Therefore, the rule is considered true.

As described earlier, it can be appreciated that such rule expressions can be categorized as global rules 66, body part rules 68, modality rules 70, and modality modifier value rules 72, which are considered contra-indicator rules (e.g. which procedures should not be used based on warnings). The procedure rules 74 determine which rules are appropriate and to what extent.

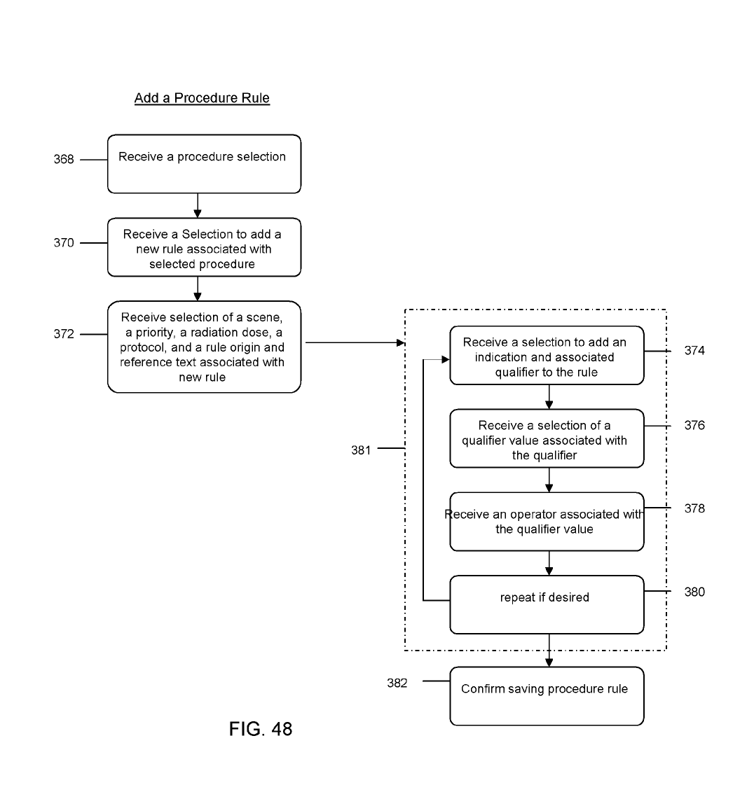

Turning to FIG. 48, example computer executable instructions are provided for adding a procedure rule. At 368, the management studio 62 receives a procedure selection. In other words, a procedure is selected from list of procedures stored in the healthcare database 18. At 370, a selection to add a new rule associated with the selected procedure is received. Upon adding a template for a new rule, at 372, then rule information is populated in association with the new procedure rule. The rule information includes a score, a priority, a radiation dose, a protocol and a rule origin. The protocol is selected from a listing of protocols (if any) that are associated with the selected procedure. The rule information may also include reference text, such as the rationale for the rule.

At 374, a selection to add an indication and a qualifier (associated with the indication) is received. The indication and qualifier are selected from a list of indications and qualifiers. At 376, based on the selected qualifier, a selection of a qualifier value is received. The qualifier value is associated with the selected qualifier. At 378, an operator associated with the qualifier value is received. Operators depend on the type of qualifier value. If the qualifier value is a Boolean type, then the available operators are ‘=’ and ‘!=’. If the qualifier value is of the list or integer type, then the operator can be any one of ‘=’, ‘>=’, ‘>’, ‘<’, ‘<=’, and ‘√=’. At 380, another condition can be added to the new rule. In other words, blocks 374, 376, and 378 can be repeated to add other indications, qualifiers values and operators to the new rule. It can be appreciated that blocks 374, 376, 378 and 380 can be collectively referred to as 381. At 382, the management studio 62 receives a confirmation that the new rule is to be saved to the rule engine 64.

An example of a procedure rule applied to the procedure “pulmonary angiography”. It is assumed the procedure, modality, body part, and protocol, as well as any qualifiers and indications have been added to the healthcare database 18 before formulating the rule. Upon determining the procedure, it can be appreciated that the modality (e.g. “angiography”) and the body part (e.g. “lungs”) that have been previously associated with the procedure (e.g. “pulmonary angiography”) are automatically associated with the new procedure rule as well. Then the rule information is populated, including setting the score to “3”, the priority to “3”, the radiation dose to “H” (e.g. high“), and the rule origin may be from the American College of Radiology. One condition is formed by the indicator “hemoptysis” and the Boolean qualifier. The hemoptysis condition reads “=true”, and relates to whether or not the condition is present. Another hemoptysis condition relates to the severity qualifier and reads “=not massive”. Another condition in the rule relates to the “CXR findings” indicator and to the associated “test results” qualifier. The CXR finding condition, regarding test results, reads “=Abnormal”. These three conditions are concatenated together to form the rule. If the conditions are satisfied, then the procedure and the associated score, priority and radiation dose would be applicable to the scenario provided by the physician, and consequently likely recommended. The new procedure rule then takes the symbolic form of “pulmonary angiography (having a score=3, priority=3 and radiation dose=H) is applicable if the following conditions are true: (hemoptysis=true) AND (hemoptysis severity=not massive) AND (CSR findings test results=abnormal)”.

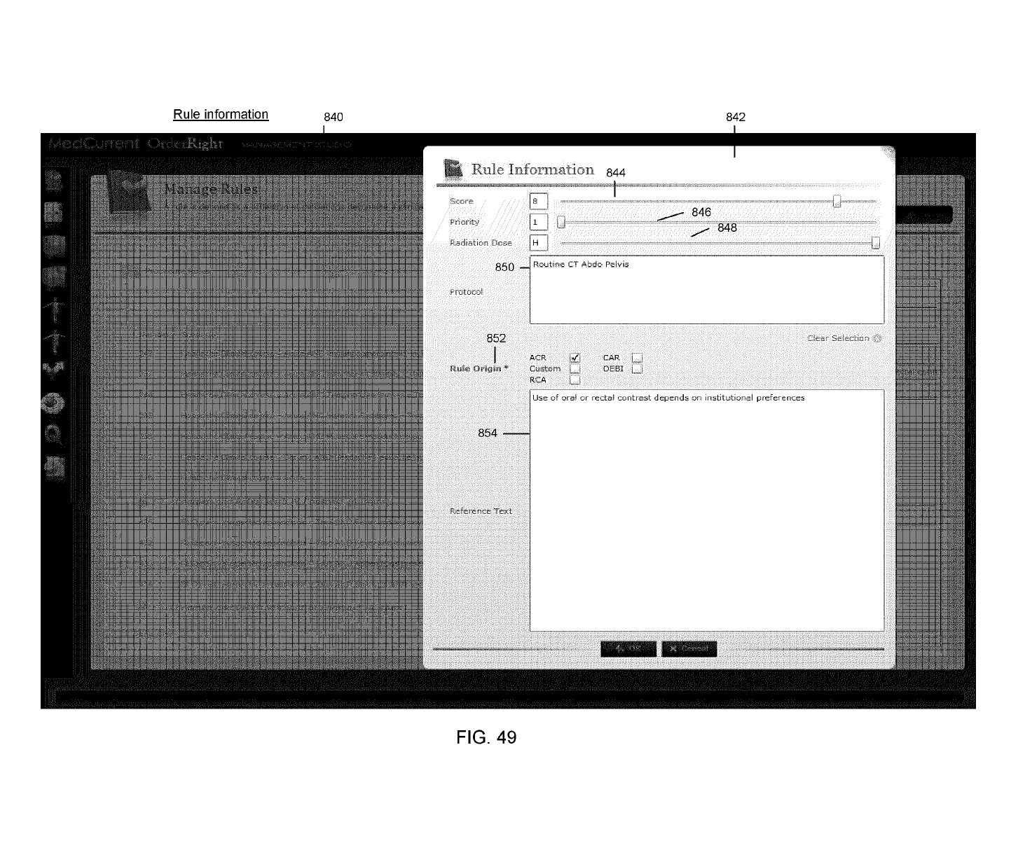

Turning to FIG. 49, an example screenshot 840 of a GUI for viewing, editing or adding rule information for procedure rules is provided in the management studio 62. In the example shown, the procedure rule is for “CT abdomen and pelvis with IV contrast”. A pop-up box or display window 842 for the rule information is provided. Controls 844, 846, 848 (e.g. slider bars as shown) can be used to adjust the score, priority and radiation dose ratings, respectively. In this example, the score is ‘8’, the priority is ‘1’, and the radiation dose is ‘H’ (e.g. high). It can be appreciated that various GUI controls for adjusting these values can be used. The associated protocol 850 is also shown as “routine CT abdo pelvis”. The rule origin 852 is shown as “ACR”. The reference text 854 shows that “use of oral or rectal contrast depends on institutional preferences”.

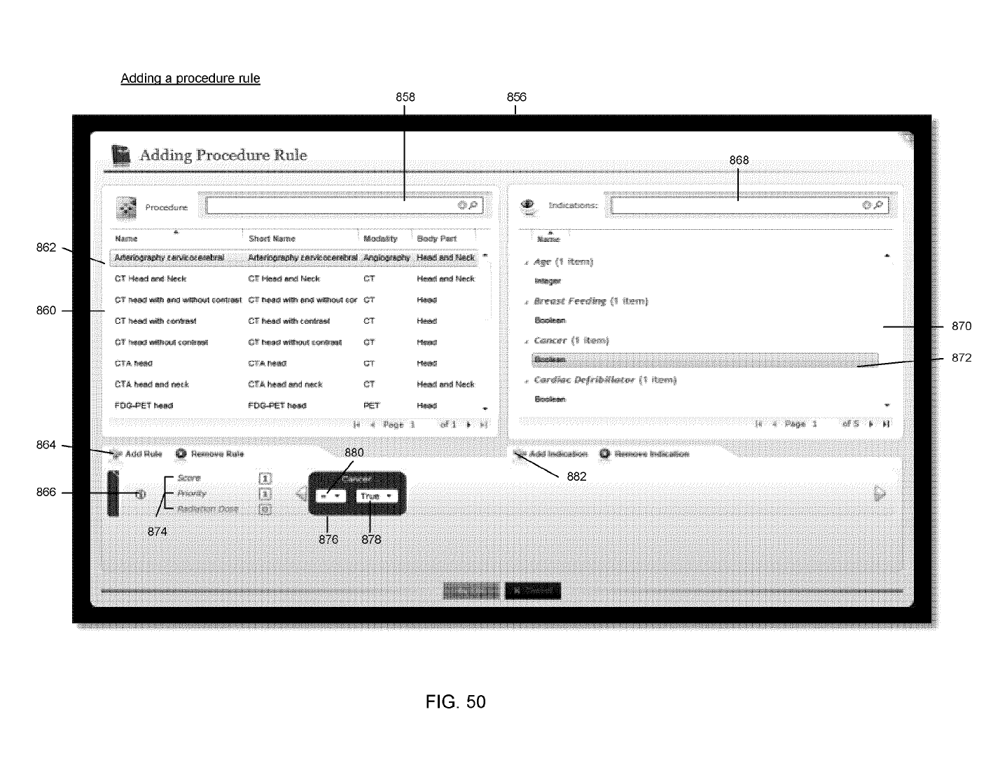

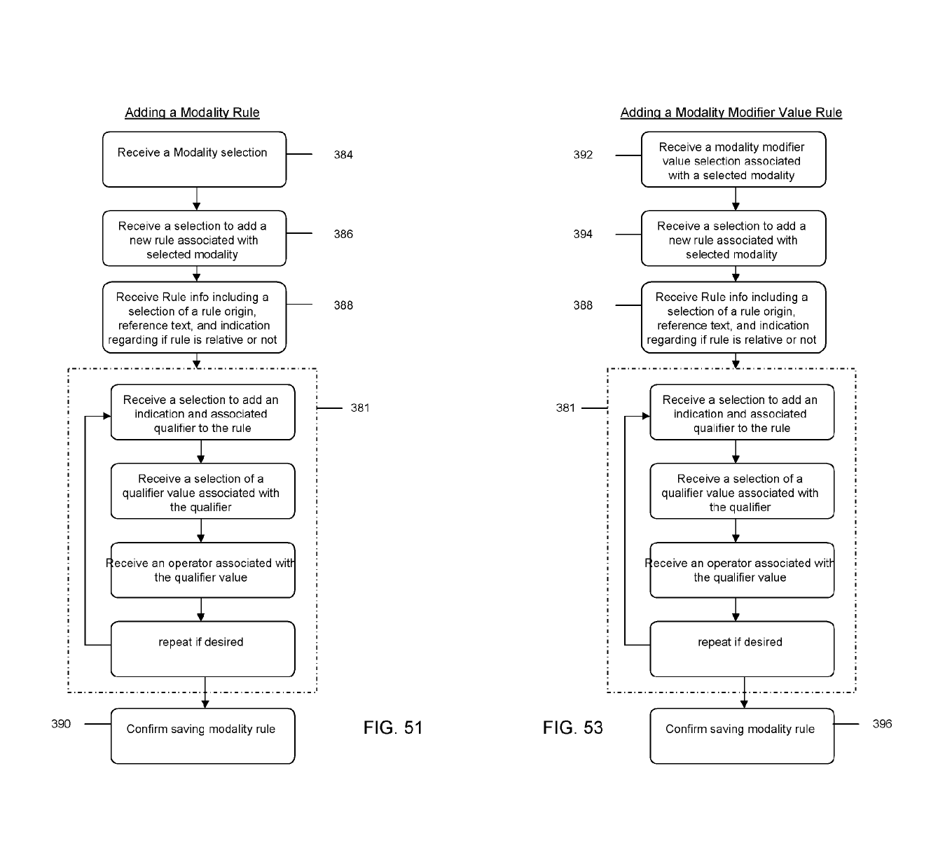

FIG. 50 shows an example screen shot 856 of a GUI for adding a procedure rule as part of the management studio 62. As described above, a user selects a procedure from a list 860 of stored procedures. The user can also search or browse for a procedure using a search bar 858. Upon selecting a procedure 862 (e.g. “arteriography cervicocerebral”), the user selects a control 864 to add a new rule based on the selected procedure 862. By selecting the rule information control 866, the user brings up a display window 842 as shown in FIG. 49. The user then populates the rule information to generate the score, priority and radiation dose 874. The user then adds a qualifier associated with an indication. Such a selection can be made from the list 870 of indicators. The indicator search bar 868 can also be used to search and browse for indicators. Upon selecting an indicator and associated qualifier 872, the selected indicator and associated qualifier can then be added to the new rule by selecting the control 882 (e.g. “add indication”). This will case the condition 876 to appear. In this case, the condition relates to the indicator “cancer” and the associated qualifier is a Boolean (e.g. has or does not have cancer). The qualifier value 878 is set to “True” in this example, although an alternative qualifier value is “False”. The operator 880 is set to “=” in this example, although an alternative operator is “!=”. Thus, the rule logic for the selected procedure 862 is “arteriography cervicocerebral (having score=1, priority=1, and radiation dose=0) is applicable if the patient indicates that: cancer=true”.

Turning to FIG. 51, example computer executable instructions are provided for adding a modality rule to the rule engine 64. At 384, the management studio 62 receives a modality selection. At 386, a selection to add a new rule is received, whereby the new rule is associated with the selected modality. At 388, rule information is received. The rule information includes a selection of a rule origin, reference text and an indication if the rule is a relative rule or not. At 381, as described above, the indication and qualifier data is selected and associated with the modality rule. Multiple conditions can be added to the modifier rule, simply by repeating the operations of 381. At 390, a confirmation is received to save the new rule to the rule engine 64.

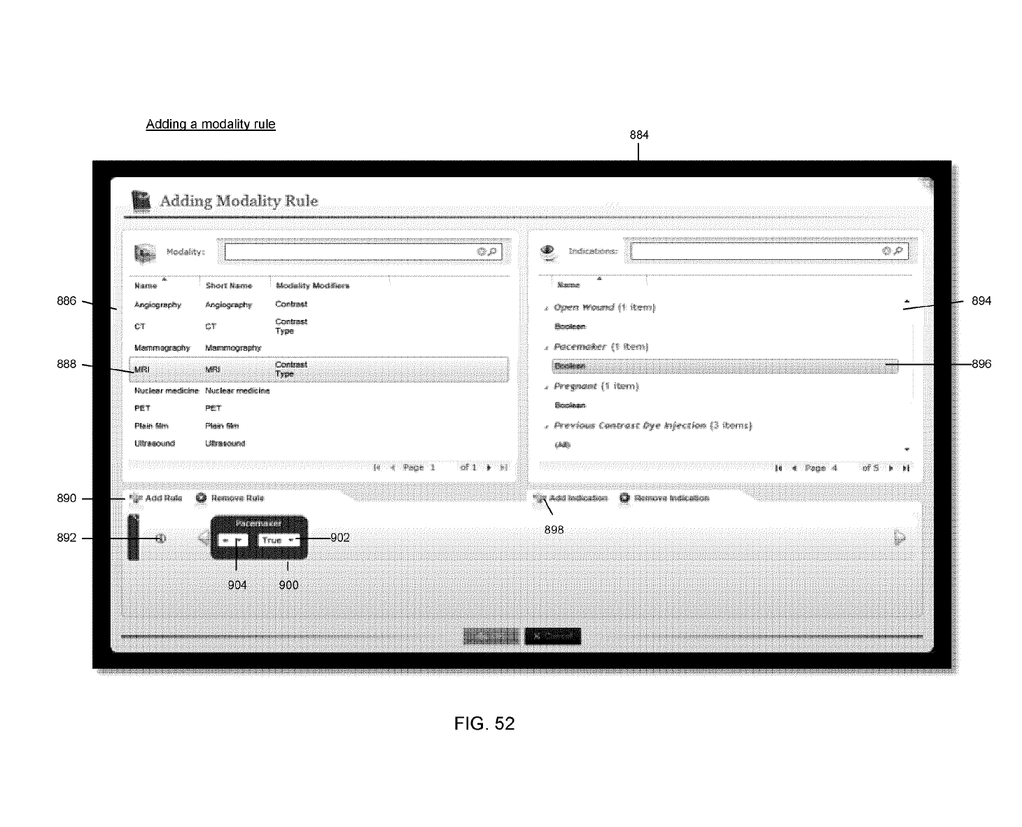

FIG. 52 shows an example screenshot 884 for adding a modality rule. A list of modalities 886 is provided. From the list, a modality 888 is selected (e.g. “MRI”). Upon selecting the control 890 (e.g. “add rule”), a new rule is added based on the selected modality 888. By selecting the control 892, the rule information (e.g. rule origin, reference text, relative rule indication) can be populated. Then an indicator and qualifier are selected from a list 894. The selected indicator and qualifier 896 relates to a pacemaker and a Boolean qualifier, respectively. The selected indicator and qualifier are added to the new rule as a condition, for example, by selecting the control 898 (e.g. “add indication”). The condition 900 appears for the pacemaker, which includes the operator “=” and the qualifier value “True”. In other words, as the modality rules (like the modality modifier rules, body part rules and global rules) are contraindication rules, the modality rule of this example can be interpreted as “do not use the MRI modality if the patient has a pacemaker”.

Turning to FIG. 53, example computer executable instructions are provided for adding a modality modifier value rule. At 392, the management studio 62 receives a modality modifier value selection associated with a selected modality. At 394, a selection to add a new rule is received, the new rule being associated with the selected modality. At 388, the rule information (e.g. rule origin, reference text, indication if rule is relative or not) is received. At 381, the indication and qualifier data is selected and added to the new modality modifier value rule to generate one or more conditions. This is described above, for example, with respect to FIG. 48. Upon adding the conditions, at 396, a confirmation is received to save the new modality modifier value rule to the rules engine 64.

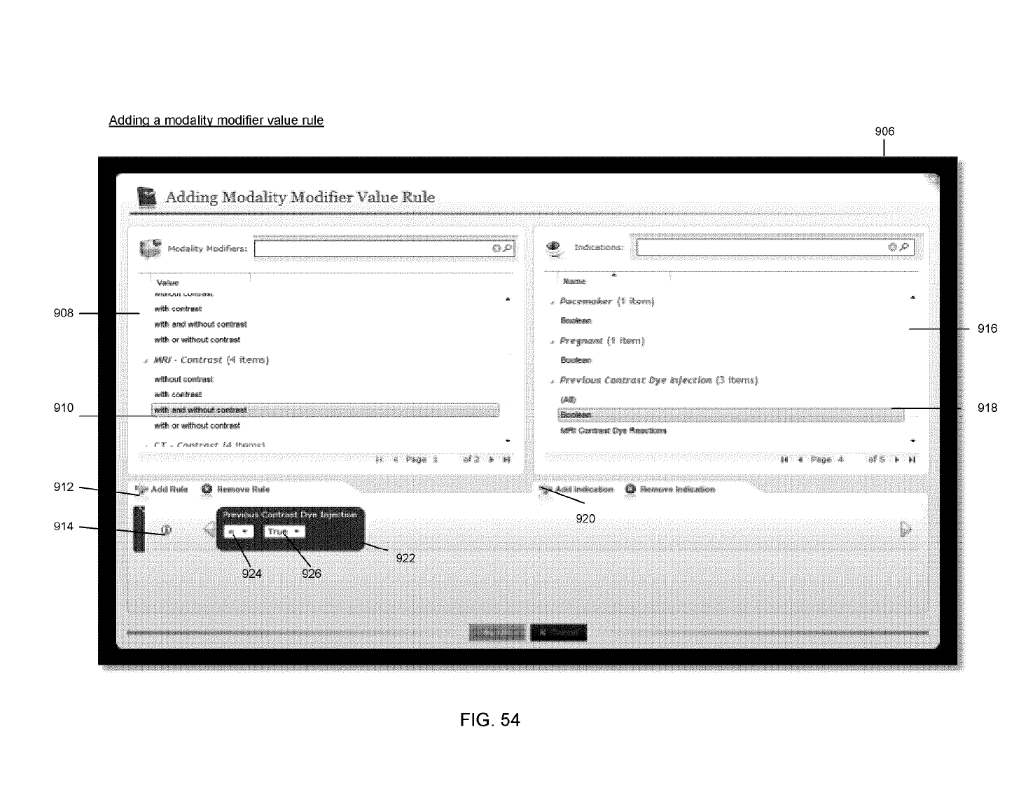

FIG. 54 shows an example screenshot 906 of a GUI for adding a modality modifier value rule as part of the management studio 62. A listing of modality modifiers 908 is shown. In this example, the modality modifiers are organized according to their associated modalities. A user is able to select a modality modifier 910 (e.g. “MRI modality with contrast”). The user then selects control 912 to add a new rule based on the selected modality modifier value 910. The user then selects the control 914 to add or populate the rule information, e.g. according to block 388. The user adds one or more conditions based on the listing of indicators and qualifiers 916. One or more qualifiers are selected. The selected indication (e.g. “previous contrast dye reaction”) and qualifier value (e.g. Boolean) 918 are added to the new rule by selecting the control 920 (e.g. “add indication”). The condition 922 then appears in the new rule and includes selections options for the operator 924 (e.g. ‘=’) and the qualifier value 926 (e.g. “True”). Upon saving or confirming the new modality modifier rule, the logic will include: “do not use MRI with contrast if the patient has previously had contrast dye reaction”.

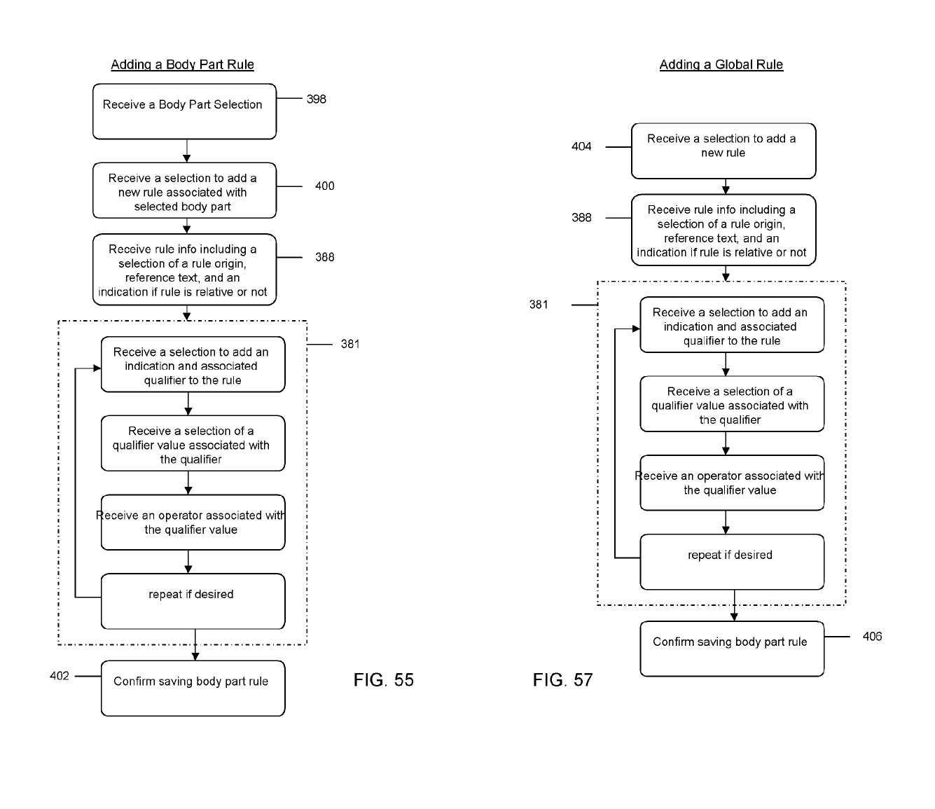

Turning to FIG. 55, example computer executable instructions are provided for adding a body part rule. At 398, the management studio 62 receives a body part selection. At 400, a selection to add a new rule associated with the selected body part is received. At 388, rule information is received. At 381, one or more conditions comprising indication and qualifier data are received. At 402, a confirmation saving the body part rule is received.

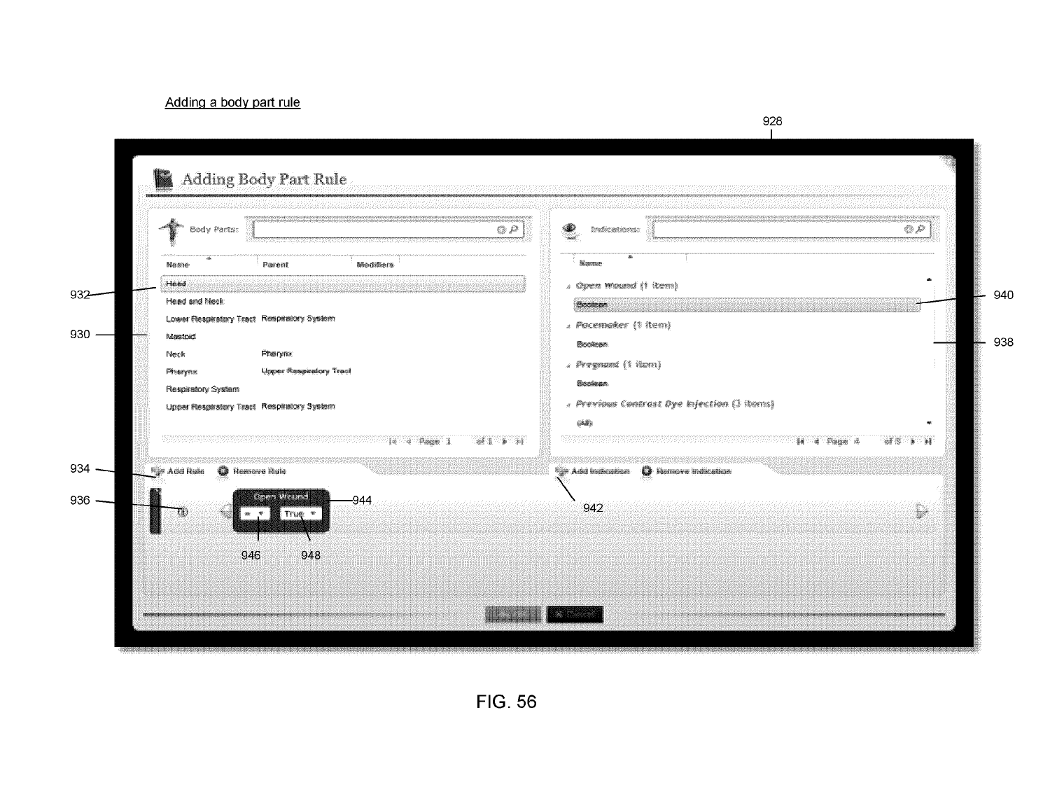

FIG. 56 shows an example screenshot 928 of a GUI for adding a body part rule as part of the management studio 62. A listing of body parts 930 allows a user to select a certain body part 932 (e.g. “head”). Upon selecting control 934 (e.g. “add rule”), a new rule is generated in associated with the selected body part 932. Selecting control 936 allows a user to populate or add rule information (e.g. rule origin, reference text, indicator if rule is relative or not). A listing of indicators and qualifiers 938 allows a user to select a certain indicator and qualifier 940 (e.g. “open wound” and “Boolean”, respectively). At 942, upon selecting the control “add indication”, the condition 944 regarding the selected indicator and qualifier 940 is added to the new rule. The condition 944 includes selection options for an operator 946 (e.g. ‘=’) and a qualifier value 948 (e.g. “True”). The logic of the rule then becomes “do not use any procedure associated with the head if the patient has an open wound”.

Turning to FIG. 57, example computer executable instructions are provided for adding a global rule. The global rule applies, regardless of modality, procedure, modality modifier, and body part. Global rules are also contraindication rules. At 404, a selection is received to add a new global rule. At 388, rule information is received. At 381, one or more conditions comprising indication and qualifier data are received. At 406, a confirmation is received to add the new global rule to the rules engine 64.

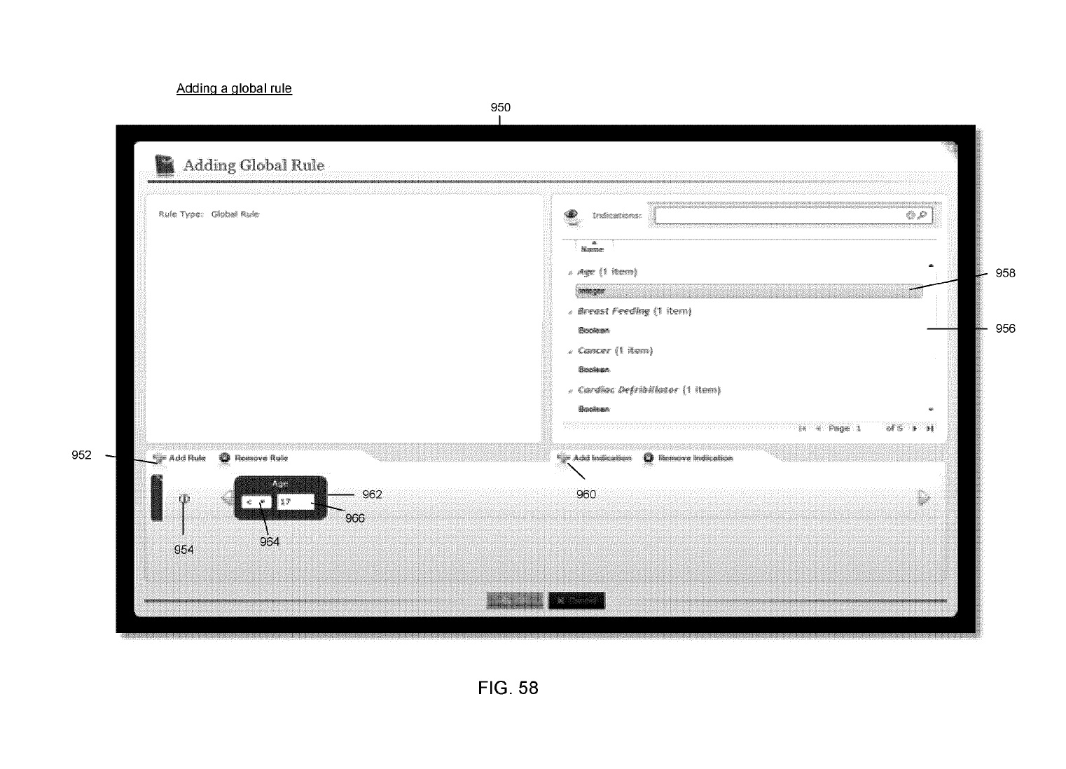

FIG. 58 shows an example screen shot 950 of a GUI for adding a global rule. By selecting control 952, a new global rule can be added. Control 954 allows a user to add or populate the rule information. A listing of indicators and qualifiers 956 allows a user to select a certain indicator and qualifier 958 (e.g. “age” and “integer”, respectively). At 960, upon selecting the control “add indication”, the condition 962 regarding the selected indicator and qualifier 958 is added to the new rule. The condition 962 includes selection options for an operator 964 (e.g. ‘<’) and a qualifier value 966 (e.g. “17”). The logic of the rule then becomes “do not use any procedure if the patient's age is less than 17 years”.

It can therefore be appreciated that a set of rules can be generated to define the recommendation operations of the healthcare system. This advantageously allows a user to directly manage a healthcare system that accommodates preferences of the user or institution. The management studio 62 also allows users to track how existing rules operate and to determine their rationale. In general, medicine is practiced locally and therefore different hospitals, regions, etc. might have differing opinions upon what the best procedure to order is in a given clinical situation.

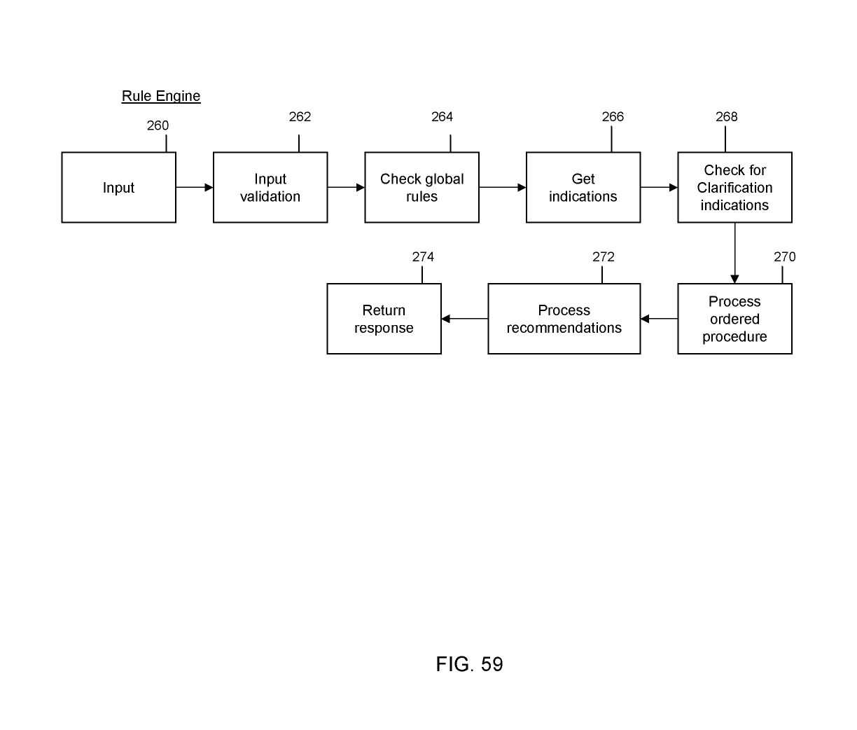

Upon entering the healthcare data 18 and the rules, it can be appreciated that the healthcare system 18 operates by executing the rules (e.g. comparing inputted data with the rules in the rules engine 64). Turning to FIG. 59, processes for the rule engine 64 are provided. At 260, inputs (e.g. indications about the patient, desired procedures) are provided and then are validated 262. At 264, it is then determined if any global rules have failed based on the inputs. At 266, indications are received. At 268, it is determined if all the indications were passed into the rule engine 64. At 270, the ordered procedure is processed, if it exists in the healthcare data 18. At 272, the recommendations, if any were requested, are processed. At 274, the result for both the ordered procedure and the recommendations are returned.

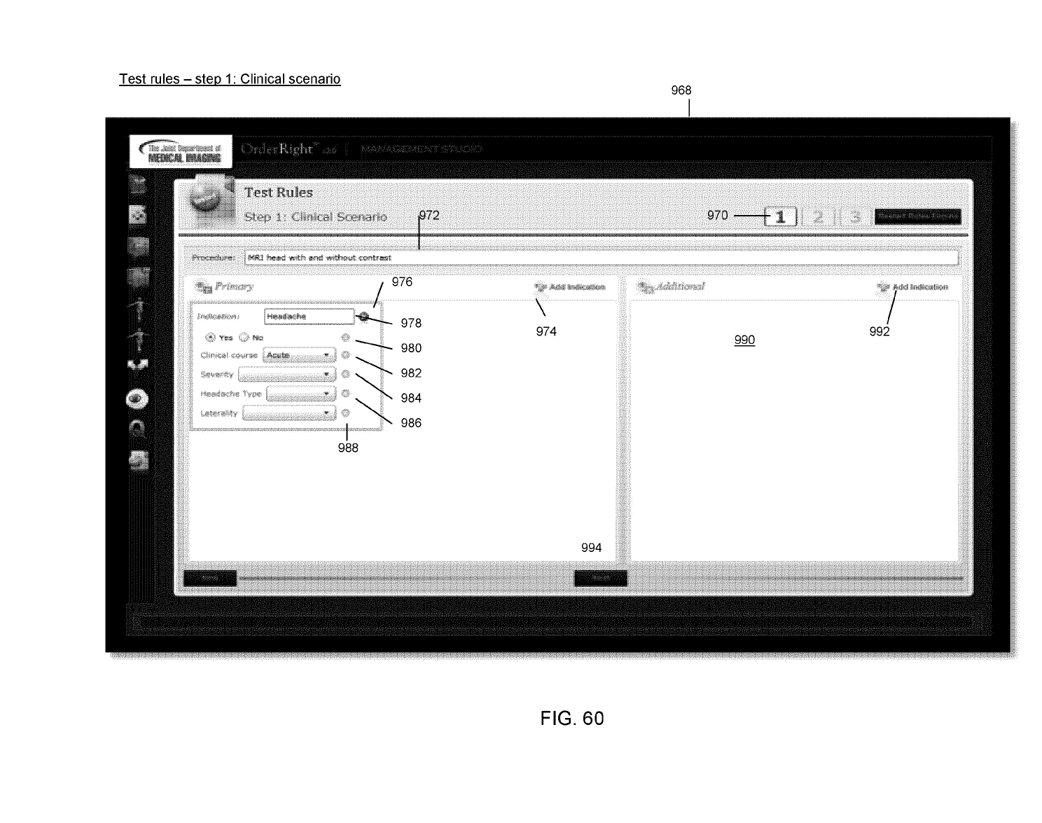

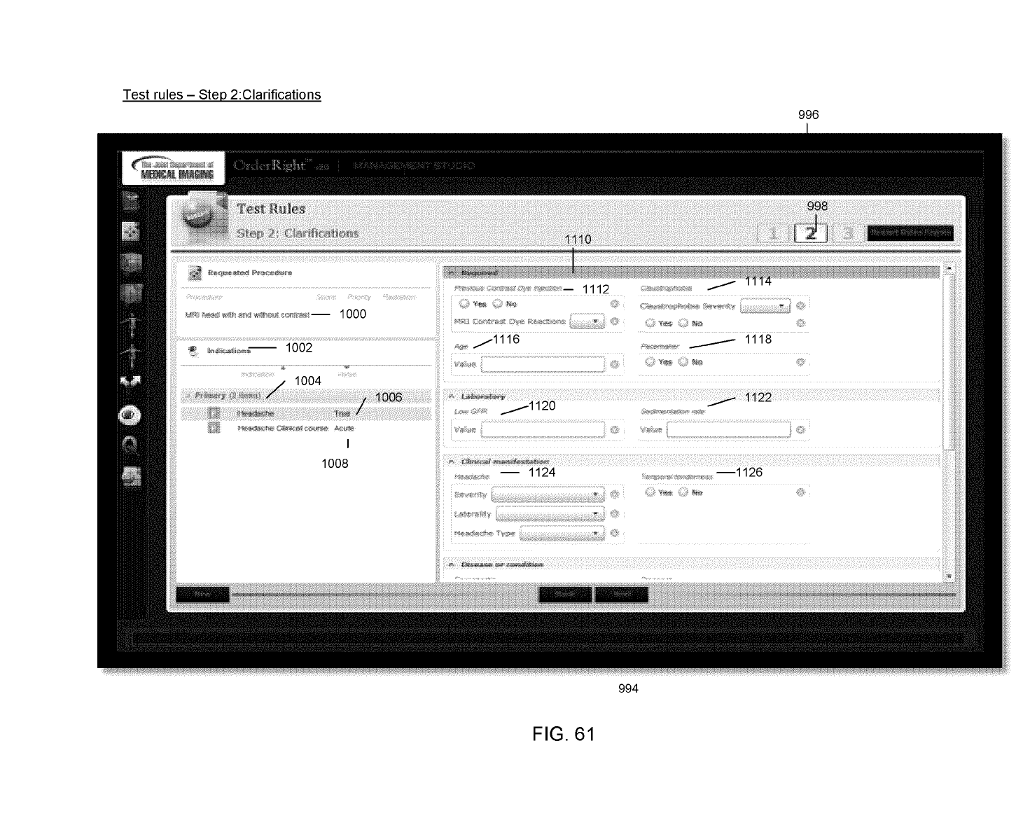

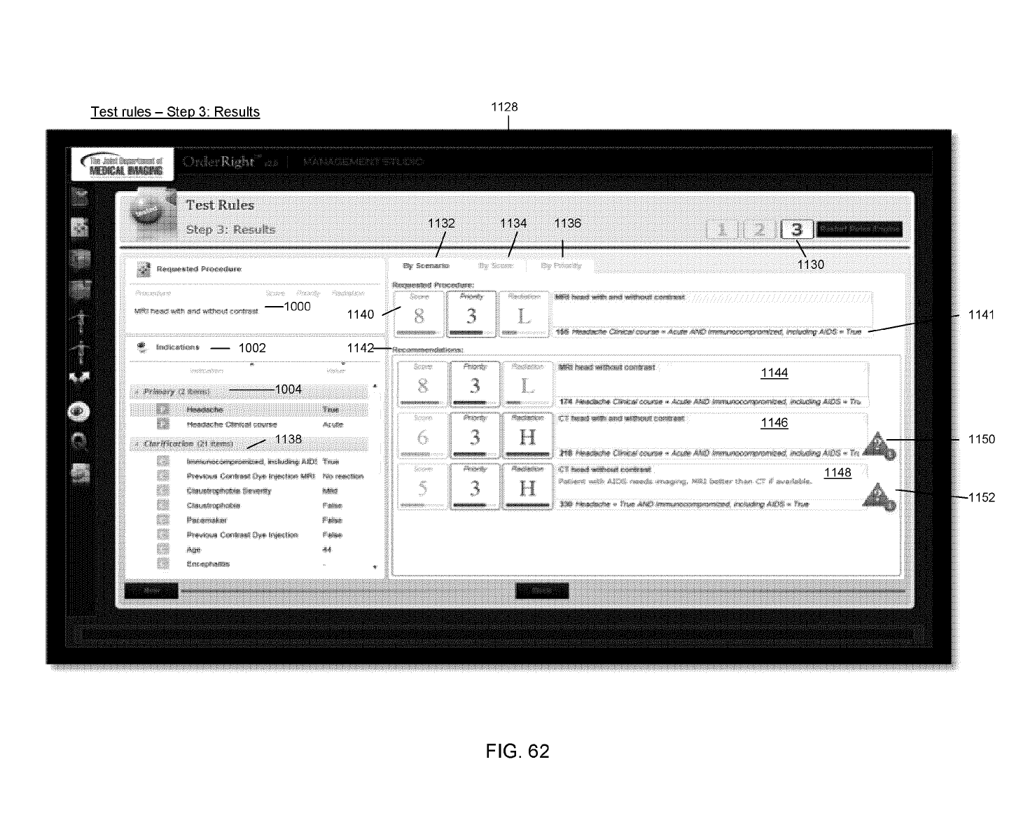

FIG. 60, FIG. 61 and FIG. 62 provide steps for entering inputs regarding a patient to determine which procedure or procedures are most appropriate.

Turning to FIG. 60, an example screenshot 968 shows a GUI for testing rules, which would be similar to the GUI used at the physician's portal 60. There are three steps for testing the rules, which includes receiving the clinical scenario, receiving any other clarifications, and then, based on the rules, returning our outputting the appropriateness score of a requested procedure as well as recommending other procedures. The screenshot 968, which is part of the management studio 62, shows the first step for entering the clinical scenario information. The step is also indicated by the number “1” 970. The user selects or enters in a requested procedure that is exists or is stored in the healthcare database 18; this information can be entered into the procedure text field 972. Upon receiving or identifying the procedure, a user can select control 974 to add one or more primary indications related to a patient. An indication options panel 976 is provided and includes an indications text field 978. Upon the healthcare system identifying the indication, the healthcare system through the management studio 62 displays all the qualifiers associated with the indication. In this case the indication is “headache”. The qualifiers associated with “headache” include Boolean 980, clinical course 982, severity 984, headache type 986, and laterality 988. The option controls associated with each qualifier are provided to allow a user to select the qualifier values of each qualifier. For example, the Boolean qualifier 908 has values “yes” or “no” and the clinical course qualifier 982 has a dropdown list to select a value (e.g. “acute”). There is also a listing of additional or secondary indications. Control 992 (e.g. “add indication”) allows a user to add additional indications. It can be appreciated that at least one primary indication with at least one associated qualifier value must be specified to define a clinical scenario. Upon selecting the “next” control 994, the management studio 62 displays another GUI for the second step of receiving any other clarifications.

FIG. 61 shows an example screenshot 996 of a GUI to allow a user to add clarifications, for example, based on the requested procedure and indications provided. The number “2” indicates that the process is at the second step for testing the rules. A summary of known data is provided and includes the name of the requested procedure 1000 (e.g. “MRI head with and without contrast”) and a listing of indications 1002. In this case, the known indications are grouped by as “primary” 1004 and include the qualifier values “headache=true” 1006 and “headache clinical course=acute” 1008. Based on the provided information, or absence of provided information, or both, a listing of required information 1110 is presented to the user. In other words, based on the rules and healthcare data 18, more information is required to determine which procedures are appropriate. Non limiting examples of required data, in this case, include qualifier values relate to the following indicators: “previous contrast dye injection” 1112, “claustrophobia” 1114, “age” 1116, “pacemaker” 1118, “low GFR” 1120, “sedimentation rate” 1122, “headache” 1124, and “temporal tenderness” 1126.

Upon the management studio 62 receiving the required qualifier values, the user can select on the “next” control 994 to proceed to another GUI regarding outputs of the appropriateness score of a requested procedure as well as recommendations of other procedures.

FIG. 62 shows an example screenshot 1128 of a GUI for displaying the results of the recommended procedure or procedures, if any. The number “3” 1130 indicates that the rule testing process is at the third step or stage. The known or collected information is shown, including the requested procedure 1000 and the indications 1002. The indications 1002 are grouped, in this example, according to primary indications 1004 and clarification indications 1138. The results are also provided.

In particular, the results can be organized or viewed according to the scenario 1132, the score 1134 and the priority 1136. In the screenshot 1128, the results of the procedures are shown according to scenario 1132. The results 1140 for the requested procedure shows the score, priority and radiation dose associated with “MRI head with and without contrast”. The procedure rule 1141 activating or leading to the result 1140 is also shown.

Other recommendations for procedures are provided. The procedures “MRI head without contrast” 1144, “CT head with and without contrast” 1146 and “CT head without contrast” 1148 are recommended. Their appropriateness ratings related to score, priority and radiation dose are provided as well. Warnings controls 1150 and 1152 may also be displayed in association with recommended procedures. For example, warning control 1150 is displayed with procedure 1146 and warning control 1152 is displayed with procedure 1148. A user can select a warning control to view the issues or warnings associated with the procedure. Warnings messages may relate to any one or more of: a requirement for the user to provide further indications based on the indications provided; warnings are applicable that may or may not lead to the procedure being contra-indicated; and warnings are applicable that one or more indications are contra-indicated.

Although not shown, it can be appreciated that other appropriateness ratings can include the cost of a test or procedure. For example, in addition to score, priority and relevance, the cost of the procedure can be used to organize the recommended tests or procedures. In other words, the cost of each procedure or test would need to be provided when entering in the healthcare data 18. This would address how decisions are made based on the associated costs. Another appropriateness rating can include whether a test or a procedure is covered or eligible for compensation by a health insurance provider.

It can be appreciated that the above systems and method provide many benefits. The methods for creating and managing rules is highly flexible and can be easily customized to cover a wide range or procedures. By providing healthcare data types as described above, rules can be readily created.

In view of the above, the proposed systems and methods provide for building a healthcare rule engine. In general, the method comprises: displaying one or more healthcare indications in a GUI; receiving a selection of one or more healthcare indications; receiving, in association with each of the one or more healthcare indications, a logic operator; and storing the one or more healthcare indications and the associated logic operators as a clinical scenario in the rule engine.

In another aspect, the method includes receiving rule information associated with the clinical scenario; combining the rule information and the clinical scenario to form a rule; and storing the rule in the rule engine. In another aspect, the rule information comprises at least a rule origin. In another aspect, the method includes receiving an input associating the rule with any one of a procedure, a modality, a modality modifier, and a body part; wherein, if the rule is associated with a procedure, the rule is a procedure rule; if the rule is associated with a modality, the rule is a modality rule; if the rule is associated with a modality modifier, the rule a modality modifier rule; and if the rule is associated with a body part, the rule is a body part rule. In another aspect, if the rule is not associated with any one of the procedure, the modality, the modality modifier, and the body part, then the rule is a global rule. In another aspect, the global rule, the modality rule, the modality modifier rule and the body part rule are contraindication rules that indicate a given procedure is inappropriate. In another aspect, the rule information for contraindication rules further comprises reference text and an indication regarding whether the rule is relative or absolute. In another aspect, the rule information for the procedure rule further comprises a score rating, a priority rating, and a radiation dose rating. In another aspect, the rule information for the procedure rule further comprises an associated protocol, the associated protocol describing execution of the procedure. In another aspect, the logic operator includes any one of: =, !=, >=, <=, >, and <. In another aspect, each of the one or more healthcare indications comprises one or more qualifiers, and a selected qualifier is stored in association with the logic operator as the clinical scenario.

The systems and methods also provide for building a healthcare rule engine through the method comprising: receiving healthcare data comprising one or more qualifiers, one or more indications, one or more body part modifiers, one or more body parts, one or more modality modifiers, one or more modalities, one or more procedures and one or more protocols; presenting the one or more procedures, the one or more indications, the one or more qualifiers and one or more logic operators in a first GUI for selection in composing a procedure rule; presenting the one or more modalities, the one or more indications, the one or more qualifiers and the one or more logic operators in a second GUI for selection in composing a modality rule; presenting the one or more modality modifiers, the one or more indications, the one or more qualifiers and the one or more logic operators in a third GUI for selection in composing a modality modifier value rule; presenting the one or more body parts, the one or more indications, the one or more qualifiers and the one or more operators in a fourth GUI for selection in composing a body part rule; presenting the one or more indications, the one or more qualifiers and the one or more operators in a fifth GUI for selection in composing a global rule; and, storing the rules in the healthcare rule engine.

In another aspect, the one or more indications are each associated with at least one of the one or more qualifiers. In another aspect, the one or more body parts are each associated with at least one of the one or more body part modifiers. In another aspect, the one or more modalities are each associated with at least one of the one or more modality modifiers. In another aspect, the one or more procedures are each associated with at least one of the one or more body parts and at least one of the one or more modalities. In another aspect, the one or more protocols are each associated with at least one of the one or more procedures.

It can be appreciated that the above-described user interfaces can vary. The buttons and controls can be activated by using a pointer, a touch screen, or other known user interface methods and systems

The steps or operations in the flow charts described herein are just for example. There may be many variations to these steps or operations without departing from the spirit of the invention or inventions. For instance, the steps may be performed in a differing order, or steps may be added, deleted, or modified.

While the basic principles of this invention or these inventions have been herein illustrated along with the embodiments shown, it will be appreciated by those skilled in the art that variations in the disclosed arrangement, both as to its details and the organization of such details, may be made without departing from the spirit and scope thereof. Accordingly, it is intended that the foregoing disclosure and the showings made in the drawings will be considered only as illustrative of the principles of the invention or inventions, and not construed in a limiting sense.

1. A method for building a healthcare rule engine, the method comprising:
displaying one or more healthcare indications in a graphical user interface (GU);
receiving a selection of one or more healthcare indications;
receiving, in association with each of the one or more healthcare indications, a logic operator; and
storing the one or more healthcare indications and the associated logic operators as a clinical scenario in the rule engine.

2. The method of claim 1 further comprising:
receiving rule information associated with the clinical scenario;
combining the rule information and the clinical scenario to form a rule; and
storing the rule in the rule engine.

3. The method of claim 2 wherein the rule information comprises at least a rule origin.

4. The method of claim 2 further comprising:
receiving an input associating the rule with any one of a procedure, a modality, a modality modifier, and a body part; wherein,
if the rule is associated with a procedure, the rule is a procedure rule;
if the rule is associated with a modality, the rule is a modality rule;
if the role is associated with a modality modifier, the rule a modality modifier rule;and
if the rule is associated with a body part, the rule is a body part rule.

5. The method of claim 4 wherein, if the rule is not associated with any one of the procedure, the modality, the modality modifier, and the body part, then the rule is a global rule.

6. The method of claim 4 wherein the global rule, the modality rule, the modality modifier rule and the body part rule are contraindication rules that indicate a given procedure is inappropriate.

7. The method of claim 6 wherein the rule information for contraindication rules further comprises reference text and an indication regarding whether the rule is relative or absolute.

8. The method of claim 4 wherein the rule information for the procedure rule further comprises a score rating, a priority rating, and a radiation dose rating.

9. The method of claim 4 wherein the rule information for the procedure rule further comprises an associated protocol, the associated protocol describing execution of the procedure.

10. The method of claim 1 wherein the logic operator includes any one of: =, !=, >=, <=, >, and <.

11. The method of claim 1 wherein each of the one or more healthcare indications comprises one or more qualifiers, and a selected qualifier is stored in association with the logic operator as the clinical scenario.

12. A Computer readable medium comprising computer executable instructions for building a healthcare rule engine, said computer readable medium comprising instructions for:
displaying one or more healthcare indications in a graphical user interface (GUI);
receiving a selection of one or more healthcare indications;
receiving in association with each of the one or more healthcare indications, a logic operator; and
storing the one or more healthcare indications and the associated logic operators as a clinical scenario in the rule engine.

13. The computer readable medium of claim 12 further comprising computer executable instructions for:
receiving rule information associated with the clinical scenario;
combining the rule information and the clinical scenario to form a rule; and
storing the rule in the rule engine.

14. The computer readable medium of claim 13 wherein the rule information comprises at least a rule origin.

15. The computer readable medium of claim 13 further comprising computer executable instructions for:
receiving an input associating the rule with any one of a procedure, a modality, a modality modifier, and a body part; wherein,
if the rule is associated with a procedure, the rule is a procedure rule;
if the rule is associated with a modality, the rule is a modality rule;
if the rule is associated with a modality modifier, the rule a modality modifier rule; and
if the rule is associated with a body part, the rule is a body part rule.

16. The computer readable medium of claim 15 wherein, if the rule is not associated with any one of the procedure, the modality, the modality modifier, and the body part, then the rule is a global rule.

17. The computer readable medium of claim 15 wherein the global rule, the modality rule, the modality modifier rule and the body part rule are contraindication rules that indicate a given procedure is inappropriate.

18. The computer readable medium of claim 17 wherein the rule information for contraindication rules further comprises reference text and an indication regarding whether the rule is relative or absolute.

19. The computer readable medium of claim 15 wherein the rule information for the procedure rule further comprises a score rating, a priority rating, and a radiation dose rating.

20. The method of claim 15 wherein the rule information for the procedure rule further comprises an associated protocol, the associated protocol describing execution of the procedure.

21. The computer readable medium of claim 12 wherein the logic operator includes any one of: =, √=, >=, <=, >, and <.

22. The computer readable medium of claim 12 wherein each of the one or more healthcare indications comprises one or more qualifiers, and a selected qualifier is stored in association with the logic operator as the clinical scenario.

23. A method for building a healthcare rule engine, the method comprising:
receiving healthcare data comprising one or more qualifiers, one or more indications, one or more body part modifiers, one or more body parts, one or more modality modifiers, one or more modalities, one or more procedures and one or more protocols;
presenting the one or more procedures, the one or more indications, the one or more qualifiers and one or more logic operators in a first graphical user interface (GUI) for selection in composing a procedure rule;
presenting the one or more modalities, the one or more indications, the one or more qualifiers the one or more logic operators in a second GUI for selection in composing a modality rule;
presenting the one or more modality modifiers, the one or more indications, the one or more qualifiers and the one or more logic operators in a third GUI for selection in composing a modality modifier value rule;
presenting the one or more body parts, the one or more indications, the one or more qualifiers and the one or more operators in a fourth GUI for selection in composing a body part rule;
presenting the one or more indications, the one or more qualifiers and the one or more operators in a fifth GUI for selection in composing a global rule; and,
storing the rules in the healthcare rule engine.

24. The method of claim 23 wherein:
the one or more qualifiers are received in a sixth GUI;
the one or more indications are received in a seventh GUI;
the one or more body part modifiers are received in an eighth GUI;
the one or more body parts are received in a ninth GUI;
the one or more modality modifiers are received in a tenth GUI;
the one or more modalities are received in an eleventh GUI;
the one or more procedures are received in a twelfth GUI; and,
the one or More protocols are received in a thirteenth GUI.

25. The method according to claim 23 wherein the one or more indications are each associated with at least one of the one or more qualifiers.

26. The method according to claim 23 wherein the one or more body parts are each associated with at least one of the one or more body modifiers.

27. The method according to claim 23 wherein the one or more modalities are each associated with at least one of the one or more modality modifiers.

28. The method according to claim 23 wherein the one or more procedures are each associated with at least one of the one or more body parts and at least one of the one or more modalities.

29. The method according to claim 23 wherein the one or more protocols are each associated with at least one of the one or more procedures.
